(19) United States
(12) Patent Application Publication
(10) Pub. No.: US 2026/0301254 A1
(43) Pub. Date: Oct. 1, 2026

(54) GRAPHICS PROCESSING

(71) Applicant: Arm Limited, Cambridge (GB)

(72) Inventor: Andreas Due Engh-Halstvedt, Trondheim (NO)

(73) Assignee: Arm Limited, Cambridge (GB)

(21) Appl. No.: 19/093,026

(22) Filed: Mar. 27, 2025

(51) Int. Cl. G06T 11/40; G06T 1/20

(52) U.S. Cl. CPC G06T 11/40; G06T 1/20; G06T 2210/12

(57) ABSTRACT

When generating a render output in which primitives to be rendered can be clipped against clip planes in a tile-based graphics processing system, it is determined whether a primitive should undergo a clipping process as part of its processing for a render output; and, if so, an effect of clipping the primitive against clip planes defined for the render output is estimated. The primitive is then processed for inclusion in one or more binning data structures based on the estimated effect of clipping of the primitive against clip planes defined for the render output. Thereafter a clipping process for the primitive is performed and the primitive is then rendered using the binning data structure(s) and the result of the clipping process for the primitive.

### BACKGROUND

The technology described herein relates to graphics processing, and in particular to the operation of a tile-based graphics processor and graphics processing pipeline when primitives to be rendered can be “clipped”.

Computer graphics processing is normally carried out by first splitting a scene (e.g. a 3-D model) to be displayed into a number of similar basic components or “primitives”, which primitives are then subjected to the desired graphics processing operations. The graphics “primitives” are usually in the form of simple polygons, such as triangles, quadrilaterals, points, lines, or groups thereof.

Each primitive is usually defined by and represented as a set of vertices (e.g. three vertices in the case of triangular primitive). For a given graphics processing output, e.g. frame to be displayed, there will typically be a set of vertices defined for the output in question. The primitives to be processed for the output will then be indicated as comprising given vertices in the set of vertices for the output being generated.

Typically, the overall output, e.g. frame to be generated, will be divided into smaller units of processing, referred to as “draw calls”. Each draw call will have a respective set of vertices defined for it and respective primitives that use those vertices. For a given frame, there may, e.g., be of the order of a few thousand draw calls, and hundreds of thousands (or potentially millions) of primitives.

Each vertex for a primitive will have associated with it a set of data (such as position, colour, texture and other attributes data) representing the vertex. This vertex data is processed by a graphics processor to generate the desired graphics processing output (render target), such as a frame for display. This typically comprises “assembling” primitives using the vertices, and then processing the so-assembled primitives.

One form of graphics processing uses so-called “tile-based” rendering. In tile-based rendering, the render output (i.e. the output of the rendering process, such as an output frame to be displayed) is rendered as a plurality of smaller area regions, usually referred to as “tiles”. The render output is typically divided (by area) into regularly-sized and shaped rendering tiles (they are usually e.g., squares or rectangles). The tiles are each rendered separately (e.g. one after another). The rendered tiles are then combined to provide the complete render output (e.g. frame for display).

Other terms that are commonly used for “tiling” and “tile-based” rendering include “chunking” (the rendering tiles are referred to as “chunks”) and “bucket” rendering. The terms “tile” and “tiling” will be used hereinafter for convenience, but it should be understood that these terms are intended to encompass all alternative and equivalent terms and techniques wherein the render output is rendered as a plurality of smaller area regions.

When performing tile-based graphics processing, there will normally be some initial geometry processing, such as vertex processing (vertex shading) of attributes for vertices to be used for primitives for the render output being generated, to generate geometry (and other) data required for rendering the graphics processing output.

The geometry processing will then be followed by a tiling/binning process that generates appropriate data structures for determining which geometry (e.g. primitives) needs to be processed for respective rendering tiles of the output being generated.

(In tile-based graphics processing, it is usually desirable to be able to (try to) identify the geometry (e.g. primitives) for the render output that need to be processed for a given rendering tile (so as to avoid unnecessarily processing geometry that does not actually apply to a rendering tile). To facilitate this, in tile-based graphics processing, there is usually a tiling/binning process that is performed that generates appropriate data structures, such as lists of primitives that apply to a tile or tiles, for use then to identify geometry that needs to be processed for a respective rendering tile.)

Once the binning/tiling process has generated the necessary data structures for identifying geometry to be processed for respective tiles of the render output, the geometry can then be, and will be, subjected to appropriate rendering/fragment processing. This may comprise, for example, rasterising primitives to be processed to fragments, fragment shading of the fragments, and/or performing ray tracing operations. This operation is performed on a tile-by-tile basis, using the data structures generated by the tiling/binning process to identify the geometry (e.g. primitives) that need to be processed for a respective rendering tile.

The rendered tiles may then be combined appropriately to provide the overall render output (e.g. frame for display).

Graphics processing may use so-called “clipping”, e.g. to avoid rendering geometry where it is not required. There may, for example, be near and far clipping planes defined for a render output (e.g. frame to be displayed), and also clipping planes that are defined around the, e.g. x and y edges, of the render output, to eliminate geometry that will fall outside the desired view port (view frustum), for example.

Graphics APIs, such Vulcan, OpenGL and Direct3D, also permit the user (the application programmer) to define one or more “user-defined” clip planes, against which geometry can be clipped (in addition to any clip planes defining the view frustum/view port boundary). Where user-defined clip planes can be used, typically a plurality, e.g. up to eight, user-defined clip planes can be defined for a given render output.

When performing clipping, when a vertex for a primitive falls outside a clip plane (such that the primitive to which the vertex belongs needs to be “clipped”), normally a new vertex or vertices that are positioned on the appropriate clip plane are defined (i.e. such that new vertices and correspondingly new primitives are defined to take account of the effect of the clipping).

FIG. 1 illustrates this and shows an exemplary primitive 101 having a vertex 102 that falls outside the desired view port clip space 103. As shown in FIG. 1, to clip the primitive 101 to the right hand plane (edge) of the clip space 103, two new vertices 104, 105 lying on that plane (edge) of the clip space 103 are generated, to thereby create two new primitives 106, 107, that fall entirely within the clip space 103 (that will then be rendered instead of the original primitive 101).

Clipping against a user-defined clip plane is performed in a similar manner, i.e. by generating appropriate new vertices that lie on the clip plane, and correspondingly new primitives including those vertices, for the rendering process.

The Applicants believe that there remains scope for improved methods and apparatus for handling clipping in tile-based graphics processing.

### BRIEF DESCRIPTION OF THE DRAWINGS

Embodiments of the technology described herein will now be described by way of example only and with reference to the accompanying drawings, in which:

FIG. 1 illustrates the operation of clipping in graphics processing;

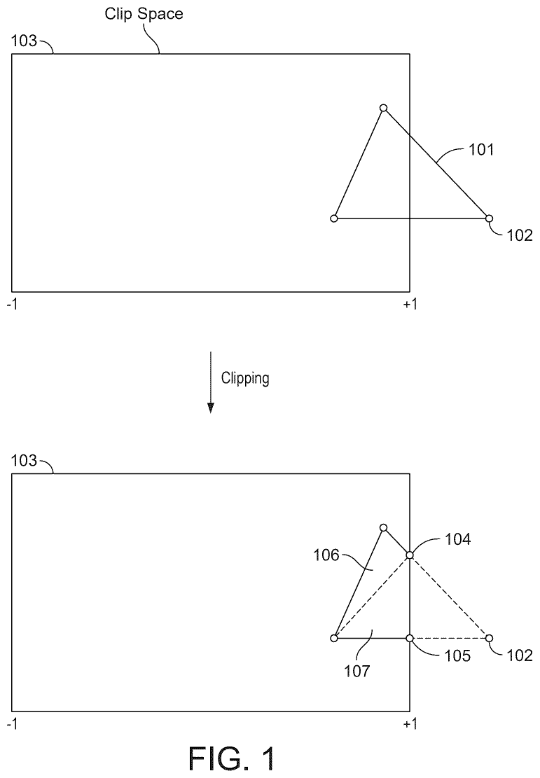

FIG. 2 shows an exemplary data processing system in which the technology described herein may be implemented;

FIG. 3 shows an exemplary graphics processing pipeline;

FIG. 4 shows schematically a graphics processor that may be operated in accordance with the technology described herein;

FIGS. 5 and 6 show exemplary binning data structures;

FIG. 7 shows an exemplary render output with exemplary clip planes;

FIG. 8 shows the binning and clipping operation in an embodiment;

FIGS. 9 and 10 show the binning and clipping operation in an embodiment in more detail;

FIGS. 11 and 12 show the effect of clipping for exemplary primitives;

FIG. 13 shows exemplary bounding boxes used for the binning process for a primitive that is to undergo a clipping process;

FIG. 14 shows an exemplary binning data structure including a primitive that is to undergo a clipping process generated by the binning process in an embodiment;

FIG. 15 shows the result of the clipping process for the exemplary primitives shown in FIG. 12; and

FIG. 16 shows an exemplary binning data structure including a primitive that is to undergo a clipping process after being updated by the clipping process in an embodiment.

Like reference numerals are used for like features in the Figures, where appropriate.

### DETAILED DESCRIPTION

A first embodiment of the technology described herein comprises a method of operating a graphics processor when executing a tile-based graphics processing pipeline to generate an output, the graphics processing pipeline being executed comprising:
a sequence of one or more geometry processing stages to perform geometry processing;
a binning stage that performs a binning process to generate data structures for identifying geometry to be processed for respective rendering tiles of a render output being generated; and
a rendering stage for rendering tiles of a render output being generated;
the method comprising, when generating a render output in which primitives to be rendered can be clipped against a clip plane defined for the render output, for a primitive to be processed for the render output being generated:
   determining whether the primitive should undergo a clipping process as part of its processing for the render output;
   when it is determined that the primitive should undergo a clipping process as part of its processing for the render output, estimating an effect of clipping the primitive against clip planes defined for the render output;
   the binning stage processing the primitive for inclusion in one or more data structures for identifying geometry to be processed for respective rendering tiles of the render output being generated based on the estimated effect of clipping of the primitive against clip planes defined for the render output;
   thereafter performing a clipping process for the primitive; and
   the rendering stage using the data structures generated by the binning stage and the result of the clipping process for the primitive for processing the primitive for the render output.

A second embodiment of the technology described herein comprises a graphics processor operable to execute a tile-based graphics processing pipeline to generate an output, the graphics processor comprising one or more processing circuits configured to execute a graphics processing pipeline comprising:
a sequence of one or more geometry processing stages to perform geometry processing;
a binning stage that performs a binning process to generate data structures for identifying geometry to be processed for respective rendering tiles of a render output being generated; and
a rendering stage for rendering tiles of a render output being generated;
the graphics processor comprising a processing circuit configured to, when generating a render output in which primitives to be rendered can be clipped against a clip plane defined for the render output:
   determine for a primitive to be processed for the render output being generated whether the primitive should undergo a clipping process as part of its processing for the render output; and
   when it is determined that the primitive should undergo a clipping process as part of its processing for the render output, estimate an effect of clipping the primitive against clip planes defined for the render output;
   wherein:
   the binning stage processing circuit is configured to process a primitive for which it has been determined that the primitive should undergo a clipping process as part of its processing for a render output for inclusion in one or more data structures for identifying geometry to be processed for respective rendering tiles of a render output being generated based on the estimated effect of clipping of the primitive against clip planes defined for the render output;
   the graphics processor comprises a clipping processing circuit configured to, after the binning stage processing circuit has processed a primitive for which it has been determined that the primitive should undergo a clipping process as part of its processing for a render output for inclusion in one or more data structures for identifying geometry to be processed for respective rendering tiles of the render output being generated based on the estimated effect of clipping of the primitive against clip planes defined for the render output, perform a clipping process for the primitive; and
   the rendering stage processing circuit is configured to use the data structures generated by the binning stage and the result of the clipping process for a primitive that has undergone a clipping process for a render output for processing the primitive for the render output.

The technology described herein relates to tile-based graphics processing, and in particular to the handling of primitives that may be “clipped” by a clip plane (whether user defined or otherwise) when performing tile-based graphics processing.

In the technology described herein, rather than performing the clipping process for a primitive (e.g., and in an embodiment, including generating any additional vertices and primitives as a result of the clipping process) before the binning process that generates the data structures for identifying geometry to be processed for respective rendering tiles of a render output being generated, it is instead determined for a primitive whether that primitive should undergo a clipping process for the render output being generated, and if so, the effect that any clipping of the primitive might have is estimated (e.g., and in an embodiment, and as will be discussed further below, in terms of how many vertices and/or primitives could result for the primitive as a result of any clipping of the primitive against clip planes defined for the render output).

The binning process/stage then “bins” the primitive and generates the appropriate binning data structures based on and using the estimated effect of clipping on the primitive.

Thus, in the technology described herein, a (potentially) clipped primitive is included in the appropriate binning data structures before the actual clipping process for the primitive, e.g. to generate any required additional vertices and primitives as a result of any clipping of the primitive, is performed.

Instead, in the technology described herein, the full clipping process, e.g., and in an embodiment, to generate any required additional vertices and additional primitives as a result of clipping of the primitive, is only performed after the binning data structures have been generated based on the estimated effect of any potential clipping of the primitive in question.

The Applicants have recognised in this regard that the actual clipping process for a primitive can be a relatively complex (and accordingly lengthy) operation, for example because the appropriate attributes, such as positions and non-position attributes such as colours, will need to be generated for each additional vertex that is generated as a result of the clipping. The clipping process for a given primitive can therefore take a relatively lengthy period of time.

The Applicants have further recognised that if this were to be performed for a primitive prior to that primitive being included in an appropriate binning data structure by the binning process in a tile-based graphics processing pipeline, that could lead to lengthy stalls (and corresponding large “bubbles”) in the binning operation for primitives that need to be clipped, and/or require large latency hiding mechanisms, which may be undesirable.

The technology described herein avoids this by instead of performing the actual clipping of a primitive prior to the binning process, only estimating the effect of any potential clipping of a primitive prior to the binning process, and then performing the binning operation based on that estimated effect of any clipping for a primitive.

The clipping itself is then performed after the primitive requiring clipping has been processed by the binning process (included in the binning data structure(s)). This will then avoid potentially having to stall the binning process in the case where a primitive is (potentially) clipped while the clipping process is completed for the primitive.

The Applicants have further recognised that by carrying out the actual clipping process for a primitive after the binning process in the technology described herein, it would be possible at that stage to configure the clipping operation more efficiently (in relation to the overall graphics processing pipeline operation), for example by performing the clipping of primitives in parallel where desired.

It would also be possible once clipping for one primitive has been started to then process the next primitive immediately, without having to wait for the clipping of the previous primitive to complete (in contrast to the case where the clipping is being performed before the binning process, where it would be necessary to wait for the clipping of one primitive to complete before the next primitive can be processed).

Accordingly, rather than having a potential stall per primitive (before the binning process) due to the clipping process, the technology described herein can be configured to only have one potential stall per overall render output (frame) (after the binning process when any primitives that need to be clipped undergo the clipping process).

The Applicants have further recognised that in practice it may be relatively rare for a primitive to be clipped, even in the case where clip planes are defined for a render output. Thus there may be only a relatively few primitives for a given render output (e.g. draw call) that are actually clipped and need to undergo any clipping processing.

Accordingly, while, as will be discussed further below, generating the binning data structures based on an estimate of the effect of clipping on a primitive may lead to some inefficiencies in terms of the generating and handling of the binning data structures as compared to if the actual clipping was performed before those data structures were generated, that should be relatively rare, and much less significant in effect as compared to the potential pipeline stalls/bubbles if performing the clipping operation for primitives prior to the binning/tiling process.

The graphics processor that is operated in the manner of the technology described herein can be any suitable and desired graphics processor (that executes a tile-based graphics processing pipeline).

The (tile-based) graphics processing pipeline that the graphics processor executes can correspondingly be any suitable and desired tile-based graphics processing pipeline that a graphics processor can execute. The graphics processing pipeline should, and in an embodiment does, comprise (at least) a sequence of one or more geometry processing stages to perform geometry processing, a binning stage that generates data structures for identifying geometry to be processed for respective rendering tiles of a render output being generated, and a rendering stage for rendering tiles of a render output being generated.

The geometry processing that is and can be performed in the technology described herein can comprise any suitable and desired sequence of one or more geometry processing stages that may be performed as part of a graphics processing pipeline.

In an embodiment, the geometry processing comprises one or more of, and in an embodiment plural of, the following geometry processing stages: an input assembly stage; a position shader (position shading); a vertex shader (vertex shading); a tessellation control shader (tessellation control shading); a task shader (task shading); a tessellation shader (tessellation shading); a mesh shader (mesh shading); a tessellation evaluation shader (tessellation evaluation shading); a geometry shader (geometry shading); and a transform feedback stage. The geometry processing may comprise one or more of these stages, as desired.

The sequence of one or more geometry processing stages is in an embodiment implemented and executed as a geometry processing pipeline, comprising the sequence of one or more geometry processing stages in question.

The geometry processing may, in effect, operate on, and process, individual geometry elements, such as, and in an embodiment, (individual) primitives (and in one embodiment, that is the case).

In an embodiment the geometry processing, in effect, operates on, and processes, respective groups of geometry elements (such as, and in an embodiment, respective groups of primitives).

In an embodiment the geometry processing generates (and processes) respective (geometry) packets that each store data for geometry to be processed (for the render output in question).

In an embodiment a (and each) (geometry) packet that the geometry processing generates stores data for a set of one or more primitives (and in an embodiment for a set of plural primitives) to be processed (for the render output in question).

Each (geometry) packet may store any suitable and desired data for the geometry (e.g. set of one or more primitives) that it relates to. For example, a (geometry) packet may, and in an embodiment does, store appropriate attributes, such as positions and other (non-position) varyings, for a set of (in an embodiment plural) vertices for the geometry (e.g. set of primitives) that the packet relates to, for example, and in an embodiment, together with a set of identifiers (indices) for the vertices that can be used to determine how the vertices are used for the geometry (e.g. primitives) that the packet relates to. A packet may also store attributes and identifiers for the geometry, e.g. primitives, itself, if desired, and/or other, e.g., state, information relating to the geometry that the packet relates to.

Other arrangements would, of course, be possible.

The initial (geometry) packets that are generated by the geometry processing may be created in any suitable and desired manner. For example geometry (e.g. primitives) and/or work items (e.g. vertices) relating to that geometry may be progressively added to a packet, e.g. until a condition for finishing the packet (and, if necessary, starting a new packet), such as a maximum amount of geometry (e.g. primitives) and/or work items for the packet being met, is reached.

In an embodiment, each respective geometry processing stage of the sequence of one or more geometry processing stages for the geometry processing (pipeline) that is being executed, generates a respective geometry packet(s), and provides that respective geometry packet as an input packet to a next geometry processing stage of the sequence (if any), with that next geometry processing stage of the sequence then processing the input packets that it receives to generate one or more output geometry packets, that are then provided as inputs to a next geometry processing stage of the sequence (if any), and so on.

Thus, in an embodiment, the first stage of the geometry processing, which in an embodiment comprises position shading or vertex shading (comprising both position shading and non-position varying shading, for example), acts as an “input packetizer” that generates initial packets storing data for geometry to be processed. These initial geometry packets are then in an embodiment appropriately processed by (any) subsequent stages of the geometry processing to generate, for example, modified versions of the initial geometry packets and/or to generate additional geometry packets, as required. For example, a mesh shader may generate multiple packets from a single input (e.g. task shader) packet.

The binning stage/process operates to generate data structures for identifying geometry (e.g. primitives) to be processed for respective rendering tiles of a render output being generated.

As the technology described herein relates to tile-based graphics processing, the render output will be, and is in an embodiment, divided into a plurality of tiles for rendering purposes and the render output is generated by separately rendering each tile the render output is divided into, and combining the rendered tiles.

(Correspondingly, the graphics processor will, and in an embodiment does, include one or more tile buffers that store rendered data for a rendering tile being rendered, e.g., until the rendering of the rendering tile has been completed, and a write out circuit coupled to the tile buffer(s) for writing (completed) rendering tiles to other storage, such as a frame buffer in external memory, for use.)

The tiles that the render output is divided into (and processed as) in this regard may comprise any suitable and desired (respective) regions (areas) of the render output that is being generated. The rendering tiles are in an embodiment all the same size and shape (i.e. regularly sized and shaped tiles are in an embodiment used), although this is not essential. The tiles are in an embodiment rectangular, and in an embodiment square. Each tile may correspond to an array of contiguous sampling positions, for example each tile being 16×16 or 32×32 or 64×64 sampling positions in size.

The binning stage/process should, and in an embodiment does, process the geometry, e.g. primitives and/or packets, it receives for processing to generate one or more data structures that can be used to determine whether (the respective) geometry, e.g. packets, should be processed for respective rendering tiles. Thus, the binning stage/process in an embodiment generates one or more data structures that can be used to determine whether geometry to be processed, and e.g., and in an embodiment, whether packets storing data for geometry to be processed, should be processed for a rendering tile.

The “binning” data structures that are generated by the binning stage/process for this purpose can take any suitable and desired form. For example, they could comprise lists of geometry (e.g. primitives or packets) to be processed for respective rendering tiles or sets of plural rendering tiles (which geometry, e.g. packet, “tile” lists can then be used to determine which geometry, e.g. primitives or packets, apply to a given tile).

In an embodiment, the (binning) data structures that can be used to determine whether geometry to be processed should be processed for a rendering tile comprise, in an embodiment hierarchies of, bounding boxes that can be used for that purpose.

Thus, in an embodiment, the binning process generates (binning) data structures that can be used to determine whether packets storing data for a set of one or more primitives to be processed should be processed for a rendering tile that comprise, in an embodiment hierarchies of, bounding boxes that can be used for that purpose. In an embodiment this comprises both bounding boxes for respective individual packets, together with bounding boxes for respective groups of plural packets (and, if desired, for respective groups of groups of plural packets, and so on, if desired).

In this case to determine geometry, e.g. packets, that should be processed for a rendering tile, the rendering tile can be, and will be, and in an embodiment is, compared against the respective bounding boxes to identify the geometry, e.g. those packets, that apply to the tile.

The binning stage/process can generate the data structures to be used to determine which geometry, e.g. primitives or packets, should be processed for a rendering tile in any suitable and desired manner. In an embodiment it uses an appropriate bounding box or boxes for geometry, e.g. for a primitive or packet, for this purpose.

For example, in the case where the binning stage/process prepares lists of primitives or packets to be processed for tiles, a bounding box for a primitive or packet can be compared to the tiles'positions to identify which tile(s) and/or sets of plural tiles the primitive or packet applies to.

In the case where the binning data structure(s) comprises bounding boxes for geometry, e.g. packets or primitives, the bounding box for geometry, e.g. a packet or primitive, can be included in those data structures appropriately.

The bounding box for geometry, e.g. a primitive or packet, for this purpose, can be determined in any suitable and desired manner. For example, in the case of a bounding box for an individual primitive, the (positions of the) vertices for the primitive can be used to derive an appropriate bounding box for the primitive. In the case of a packet comprising plural primitives, the positions of (the vertices of) the primitives for the packet can be used to derive a bounding box for the packet as a whole.

Other arrangements would, of course, be possible.

Where appropriate, the processing in an embodiment also comprises determining bounding boxes for the individual primitives in a packet, and using those individual primitive bounding boxes to derive a bounding box for the (processed) packet that the binning stage is generating, and to generate one or more binning data structures that can be used to determine whether the primitives should be processed for a rendering tile (which may, e.g., comprise generating appropriate lists of primitives to be processed for a rendering tile or sets of plural rendering tiles based on the primitive bounding boxes, and/or including the primitive bounding boxes in the bounding box based binning data structures that the binning stage generates, as appropriate).

In an embodiment, the binning stage/process also performs (appropriate) culling operations for primitives, e.g., and in an embodiment to, (try to) cull primitives based on the view frustum and/or the facing direction of the primitives.

In an embodiment, the binning process operates to generate respective (primitive) packets that each store data for a set of one or more primitives (and in an embodiment for a set of plural primitives) to be rendered. These primitive packets may, e.g., and in an embodiment, be generated based on and using (geometry) packets generated by previous geometry processing.

Each (primitive) packet generated by the binning process may store any suitable and desired data for the set of one or more primitives that it relates to. It can, and in an embodiment does, store appropriate attributes, such as positions and, in an embodiment, other (non-position) varyings, for a set of (in an embodiment plural) vertices for the set of primitives that the packet relates to, for example, and in an embodiment, together with a set of identifiers (indices) for the vertices that can be used to determine how the vertices are used for the primitives that the packet relates to. The packet in an embodiment also stores one or more bounding boxes corresponding to and for use in relation to the primitives that the packet relates to.

A (primitive) packet generated by the binning process may also store attributes and identifiers for the primitives themselves, if desired, and/or other, e.g., state, information relating to the primitives that the packet relates to.

In an embodiment the binning process generates packets that indicate for a primitive that the packet relates to (includes) one or more of, in an embodiment plural of, and in an embodiment all of: a bounding box for the primitive, an identifier for the primitive, an instance identifier for the primitive (where necessary), and the vertices for the primitive (in an embodiment by specifying the location of the attributes for the vertices of the primitive in the packet). This may be done, for example, and in an embodiment, by including appropriate “primitive” commands in the packet indicating this information. The packet in an embodiment also stores vertex attributes, including at least vertex positions, and in an embodiment other (non-position) attributes, for the vertices for the primitives that it relates to.

The binning process in an embodiment also generates and stores in an appropriate data structure(s) (whether in the primitive packets themselves or as a separate data structure(s)) bounding boxes for the respective packets that it is generating, and, in an embodiment, bounding boxes for respective groups of such packets (and so on, as desired).

Once the binning stage has generated the necessary binning data structures, then the (geometry for the) render output can be rendered (by the rendering stage of the graphics processing pipeline).

The rendering will be performed on a tile by tile basis (as the graphics processor is executing a tile based graphics processing pipeline), and so accordingly, the rendering stage will, and in an embodiment does, use the binning data structures generated by the binning stage to identify geometry, e.g. packets, to be processed for respective rendering tiles. Thus, for a (and each) rendering tile to be processed for generating the rendering output, the binning data structure(s) generated by the binning stage will be, and are in an embodiment, used to identify geometry, e.g. packets storing data for geometry, to be processed for the rendering tile in question.

This can be done in any suitable and desired manner, and should, and in an embodiment does, depend upon the nature of the binning data structures that the binning stage has generated. For example, where the binning stage generates lists of primitives and/or packets to be processed for respective rendering tiles or sets of rendering tiles, those lists can be used to identify the primitives and/or packets to be processed for a rendering tile. Where the binning stage generates (hierarchies of) bounding boxes, e.g. for packets, a rendering tile and/or region of the render output may be compared to the bounding boxes to determine the, e.g. packets, that need to be processed for the rendering tile and/or region in question.

(Correspondingly, the rendering stage in an embodiment should, and in an embodiment does, comprise an initial process of using the binning data structure(s) generated by the binning stage to identify geometry, e.g. packets, to be processed for rendering tiles.)

Once the geometry (e.g. primitives or packets) to be rendered for a rendering tile has been identified, then the tile can be rendered.

The rendering processing that is performed for a tile can be any suitable and desired rendering processing that may be performed by a graphics processor and a graphics processing pipeline. Thus this may comprise, for example, rasterising primitives to fragments and fragment shading the fragments, and/or performing ray tracing processes, etc..

Other arrangements would, of course, be possible.

The technology described herein relates in particular to the situation where one or more clip planes have been defined for a render output, such that primitives to be processed for the render output could need to be clipped against one or more clip planes.

The render output that is being generated and for which one or more clip planes are defined can be any suitable and desired render output that the graphics processing being performed can be subdivided into (and, e.g., that is identifiable (identified) as a distinct and separate (render) output of the overall graphics processing being performed).

In an embodiment, the render output corresponds to a subset of the processing for producing an overall output, such as an output frame (e.g. to be displayed). Thus the render output is in an embodiment one of a sequence of plural render outputs that together serve for generating an output frame or sequence of output frames. In an embodiment, the render output comprises a (single) draw call.

(The overall render output that is being generated can be any suitable and desired output that a graphics processor and a graphics processing pipeline may be used to generate. In an embodiment the (overall) render output is an image (frame) for display, but it can be any other form of graphics processing output, such as graphics textures in a render-to-texture operation, etc., that a graphics processor and graphics processing pipeline may produce, as desired.)

The clip planes defined for a render output in this regard (and that will correspondingly be considered and if necessary used when processing a primitive) can be any suitable and desired clip planes that may be defined for a render output.

Thus the clip planes that are considered in the technology described herein may comprise one or more user defined clip planes and/or one or more view frustum/view port clip planes, such as near and far planes and (minimum and maximum) X and Y view port “edge” clip planes. The clip planes can be defined in any suitable and desired manner, for example, and in an embodiment, in the normal manner for the graphics processor and graphics processing system (and graphics API) in question.

Thus a (and each) user-defined clip plane that is defined for a render output is in an embodiment defined by defining for each vertex defined for the render output in question, the distance from that vertex to the user-defined clip plane in question.

Thus, in an embodiment, each vertex that is defined for the render output being generated has a respective user-defined clip plane “clip distance” defined for and associated with it for each user-defined clip plane that is defined for the render output, indicating the distance from the vertex to the user-defined clip plane in question.

(The clip distance from a vertex to a given user-defined clip plane may be, for example, and in an embodiment, determined and defined as part of the vertex shading process for the vertex in question: the vertex shading will generate and output as part of the vertex shaded data for a vertex, a clip distance for (to) each user-defined clip plane.)

Other (non-user defined) clip planes, such as screen space and view port (e.g. near and far and/or X and Y “edge”) clip planes, can correspondingly be defined in the normal manner for such clip planes in the graphics processor and graphics processing system (and graphics API) in question.

In the technology described herein, prior to any binning processing of a primitive, it is determined whether the primitive should undergo (be subjected to) a clipping process for the render output being generated.

It can be determined whether a primitive should undergo (be subjected to) a clipping process for a render output in any suitable and desired manner. This determination is in an embodiment done in an appropriately conservative manner, i.e. such that it will only be determined that a primitive should not undergo a clipping process for the render output where that can be determined with certainty.

In an embodiment, this determination comprises determining whether the primitive could be clipped by a clip plane defined for the render output. This test can be performed in any suitable and desired manner, for example, and in an embodiment, in accordance with the normal manner for determining whether a primitive could be clipped by a clip plane in the graphics processor and graphics processing system in question.

Thus, in the case of user defined clip planes, it is in an embodiment determined whether a primitive could be clipped by a user defined clip plane defined for the render output by considering and using the distances to the user-defined clip plane defined for and associated with the vertices of the primitive in question, and in an embodiment using the signs of the distances to the user-defined clip plane defined for and associated with the vertices of the primitive in question.

In an embodiment, when all of the distances to the user-defined clip plane defined for and associated with the vertices of the primitive in question have the same sign (i.e. are either all positive or all negative) (and are non-zero) then it is determined that the primitive could not be clipped by the user defined clip plane in question (the user-defined clip plane does not intersect the primitive).

Correspondingly, when the distances to a given (the same) user-defined clip plane for different vertexes associated with a primitive differ in sign to each other, it should be, and is in an embodiment, determined that the primitive could be clipped by the user defined clip plane (that the user-defined clip plane could intersect the primitive) (and thus that the primitive should undergo a clipping process for the render output being generated).

In an embodiment, where a primitive can be culled from further processing on the basis of a user-defined clip plane, that is done.

In the case of “view frustum” clip planes, such as near and far clip planes, and (minimum and maximum) X and Y view port (edge) clip planes, then again it can be determined whether a primitive could be clipped by any of those clip planes in any suitable and desired manner, such as, and in an embodiment, in accordance with the usual manner for doing such a determination for the graphics processor and graphics processing system in question.

At least in the case of the X and Y view port edge clip planes (if defined for a render output), this “could be clipped” test, in an embodiment uses and considers a “guard band” around the defined view port edges (around the clip planes defining the view port edges). In other words, rather than testing the primitive against the actual defined view port edge clip planes to determine if the primitive could be clipped by those clip planes, the primitive is tested against corresponding “clip plane” edges that are set a particular margin (a particular guard band) outside the actual view port edges. Such use of a guard band around the view port edges will reduce the likelihood of a primitive needing to be clipped in relation to the view port edges.

Again, in the case of view frustum/view port clip planes, in the case that it can be determined at this stage that a primitive can be culled from further processing on the basis of any of those clip planes, the primitive is in an embodiment culled from further processing on that basis.

In an embodiment, as well as determining whether a primitive could be clipped by a clip plane defined for the render output (so as to thereby determine whether the primitive should undergo a clipping process as part of its processing for the render output being generated), a primitive is also determined as needing to undergo a clipping process (in an embodiment even if there are no clip planes defined for the render output) in the case where the primitive is very large (exceeds a particular, in an embodiment selected, in an embodiment predetermined, threshold primitive size).

In an embodiment, a primitive is also or instead (and in an embodiment also) determined as needing to undergo a clipping process in the case where the primitive intersects both the near and the far plane (which can be determined in any suitable and desired manner), and the depth range (between the near and far planes) is below a particular, in an embodiment selected, in an embodiment predetermined, threshold value (to assess this, a suitable conservative estimate of the depth range can be made). This may help to handle primitives where the primitive intersects both the near and the far plane, but the depth range is zero.

It would be possible in this regard simply to determine on the basis of any of these tests whether a primitive should undergo a clipping process, and once one of these tests to indicate that the primitive should undergo a clipping process is met, simply determine that the primitive should undergo the clipping process at that point (and in one embodiment this is what is done).

Thus, in this case, once it has been determined, for example, that a primitive could be clipped by a user-defined clip plane, the processing of the primitive to determine whether the primitive should undergo a clipping process for the render output will be stopped (and it will be determined that the primitive should undergo a clipping process for the render output), e.g. without further testing the primitive against other user-defined clip planes that the primitive has still to be tested against (or otherwise).

However, in an embodiment, it is tested for each of the clipping planes defined for the render output whether the primitive could be clipped by that clip plane, and a count is maintained of how many of the clip planes defined for the render output the primitive could be clipped by. Thus, for example, and in an embodiment, when determining whether a primitive should undergo a clipping process for the render output, the primitive is in an embodiment tested against each of the view frustum clip planes and each of the user defined clip planes (if any) for the render output, and the number of clip planes that the primitive could be clipped by is determined (and tracked).

As will be discussed further below, determining the number of clip planes that a primitive could be clipped by may be beneficial for estimating the effect of any potential clipping on the primitive.

The determination of whether a primitive should undergo a clipping process for a render output can be performed by any suitable and desired element or component (circuit) of the graphics processor. For example, this may be done by execution of an appropriate (shader) program by a programmable processing unit (circuit) (execution engine) of the graphics processor.

In one embodiment, the graphics processor comprises a, in an embodiment dedicated, fixed function unit (circuit) that performs some or all of the determination of whether a primitive should undergo a clipping process for a render output.

In an embodiment, the binning process (the binning stage) of the graphics processor and graphics processing pipeline performs the determination of whether a primitive should undergo a clipping process for a render output (and thereafter performs the binning process for the primitive in question accordingly).

It will be appreciated in this regard that the determination of whether a primitive should undergo a clipping process for a render output should comprise any necessary operations and tests for making that determination, but should not and will not include performing the actual clipping process itself for a primitive.

Thus this determination may, and in an embodiment does, determine, as discussed above, whether a primitive could be intersected by a clip plane (and as such need to undergo a clipping process), but the determination should not and in an embodiment does not determine any results of that potential intersection of the primitive by a clip plane (such as determining any additional vertices and/or primitives as a result of that intersection). Rather the determination of whether a primitive should undergo a clipping process for a render output should, and in an embodiment does, simply and solely determine that there could potentially be an intersection of a primitive with a clip plane, without determining, for example, any effect of that intersection.

When it is determined that a primitive should undergo a clipping process for a render output, an effect of the clipping of the primitive against clip planes defined for the render output is then estimated. The estimating of an effect of the (potential) clipping of a primitive against clip planes defined for a render output can be performed in any suitable and desired manner.

In an embodiment, the estimating of the effect of clipping of a primitive against clip planes defined for a render output comprises estimating a number of vertices and/or of primitives that could result (need to be processed) (that there could be) for the primitive as a result of the clipping of the primitive against clip planes defined for the render output in question.

In this case, whether only a number of vertices, or only a number of primitives, or both a number of vertices and a number of primitives, that could result for a primitive as a result of clipping of the primitive is estimated may, and in an embodiment does, depend upon the nature of the binning data structures that the binning stage generates. For example, in the case where, as discussed below, the binning data structures generated by the binning process only indicate vertices for clipped primitives, it may only be necessary to estimate a number of vertices that could result for a primitive as a result of any clipping of the primitive.

The estimating of the effect of the clipping process on a primitive (e.g. of the number of vertices and/or primitives that could result as a result of the clipping process for a primitive) is in an embodiment performed in an appropriately conservative manner. Thus the estimating process is in an embodiment configured and operates such that it cannot produce an underestimate of the effect of the clipping process on a primitive (e.g. in terms of the number of vertices and/or primitives that could result as a result of the clipping process for a primitive) (is configured such that, if the estimated effect of the clipping process on/for a primitive is in error, the estimate will be an erroneous overestimate (and not an underestimate) of the effect of the clipping process on the primitive).

In an embodiment a “worst case” estimate is determined. For example, and in an embodiment, a worst case estimate of the number of vertices and/or primitives that could result for a primitive as a result of clipping is in an embodiment estimated.

In an embodiment, the estimate is based on the number of clip planes that are defined for the render output (and in an embodiment on the number of those clip planes that it is determined that the primitive could be intersected by (where that is determined)).

The Applicants have recognised in this regard that the number of vertices and primitives that could result for a primitive as a result of clipping will, at least in certain circumstances, depend on the number of clip planes that a primitive intersects (and so should actually be clipped against).

In particular, at least in the case of triangular primitives (triangles), intersecting a clip plane will result in (at most) two vertices that need to be processed for a triangle (as the intersection will produce two new vertices, one at each intersection point, but at least one (and possibly two) of the original vertices will no longer be used as a result of the clipping).

Thus, for triangles at least, and assuming that any original vertices that are no longer needed are discarded (as part of the clipping process), a worst case estimate of the result of clipping can be that each intersected clip plane will generate one more vertex (over and above the original (three) vertices for the triangle).

Correspondingly, for triangles at least, a worst case estimate of the result of clipping can be that each intersected clip plane will generate one more triangle (over and above the original triangle).

Thus, at least in the case of triangular primitives, when clipping against N clip planes, at least in the case where any original vertices that are no longer needed are discarded (as part of the clipping process) (and in an embodiment that is done), a conservative estimate of the number of vertices and primitives that could result from the clipping process is that each clip plane produces one extra vertex (so 3+N vertices in total as a result of the clipping process), and one extra triangle (so 1+N triangles in total). Thus, for example, with 6 view frustum planes and 8 user clip planes, the theoretical worst case result of the clipping process will be 17 vertices and 15 triangles.

Thus, in an embodiment when determining a (worst case) estimate of a number of vertices that could result for a primitive as a result of the clipping of the primitive against clip planes defined for a render output, it is estimated that there will be one additional vertex (in addition to the primitive's original vertices) generated per clip plane that the primitive (potentially) needs to be clipped against (potentially will be clipped by).

Correspondingly, in an embodiment when determining a (worst case) estimate of a number of primitives that could result for a primitive as a result of the clipping of the primitive against clip planes for a render output, it is estimated that there will be one additional primitive (in addition to the original primitive) generated per clip plane that the primitive (potentially) needs to be clipped against (potentially will be clipped by).

It would be possible in this regard simply to base the estimate of the number of vertices or primitives on the maximum number of clip planes defined for a render output when it is determined that a primitive needs to undergo a clipping process for a render output (and irrespective of the number of the clip planes for the render output that the primitive may actually (potentially) be clipped by) (and in one embodiment this is what is done).

Thus in this case, where there are N clip planes defined for a render output (whether view frustum clip planes or user defined clip planes or otherwise), when it is determined that a primitive should undergo a clipping process for the render output, it may be, and is in an embodiment, estimated that N+3 vertices and N+1 primitives could result for the primitive as a result of the clipping process.

In an embodiment, where it is determined, as discussed above, for each of the clip plates defined for a render output, whether a primitive could (potentially) be clipped by the clip plane (a count of the number of potentially “clipping” clip planes is determined), then the estimate of the number of vertices and primitives that could result for a primitive as a result of clipping of the primitive against clip planes defined from a render output is based on and set in accordance with the number of clip planes that it was determined the primitive could be clipped by for the render output.

Thus in this case, where it is determined that a primitive could be clipped by (could intersect) M clip planes defined for a render output (whether view frustum clip planes or user defined clip planes or otherwise), it may be, and is in an embodiment, estimated that M+3 vertices and M+1 primitives could result for the primitive as a result of the clipping process.

Thus, for example, where it is determined that a triangular primitive could be clipped by three clip planes, it will be estimated that six vertices and four primitives could result for the primitive as a result of the clipping of the primitive against clip planes for the render output.

(In the case where any original vertices that are no longer needed are not discarded (e.g. as part of the clipping process) then the (worst case) estimate will (need to) be a correspondingly larger number of vertices.)

Thus, in an embodiment, the method of the technology described herein comprises (and the processing circuit is correspondingly configured to):
determining whether a primitive should undergo a clipping process for a render output being generated by determining whether the primitive could be clipped by any of the clip planes defined for the render output;
counting the number of clip planes defined for the render output that the primitive is determined as potentially being clipped by; and
estimating the effect of the clipping of the primitive against clip planes defined for the render output by estimating a number of vertices and/or of primitives that could result for the primitive as a result of the clipping of the primitive against clip planes defined for the render output based on the count of potentially clipping clip planes for the primitive.

Other arrangements would, of course, be possible.

Once the effect of clipping of a primitive that should undergo a clipping process for a render output being generated has been estimated (e.g. the number of vertices that could result for the primitive as a result of clipping of the primitive has been estimated), the primitive can then be, and is in an embodiment, subjected to the binning process by the binning stage/circuit based on the estimated effect of the clipping of the primitive against clip planes defined for the render output.

The binning process will accordingly, and does in an embodiment, include the primitive in an appropriate binning data structure or structures, based on the estimated effect of the clipping of the primitive against clip planes defined for the render output.

As discussed above, the binning process will use an appropriate bounding box for a primitive for the binning process (e.g., and in an embodiment, to determine which primitive/packet lists the primitive should be included in, and/or for inclusion as a bounding box in a bounding box based binning data structure).

The bounding box that is used by the binning process for a primitive that is to undergo a clipping process that is being processed in the manner of the technology described herein can comprise any suitable and desired bounding box for the primitive.

In an embodiment, rather than using the bounding box for the primitive as it will be after the primitive has undergone the clipping process, a bounding box that is determined without the primitive needing to undergo the clipping process is used for the primitive for this purpose (i.e. rather than determining the actual bounding box for the primitive after it has undergone the clipping process, an “estimated” bounding box for the “clipped” primitive is used for the binning process for a primitive that is to undergo the clipping process). This will then reduce the processing burden for determining the bounding box to use for the binning process for a primitive (albeit at the cost of using a less accurate bounding box for the primitive that is to undergo the clipping process).

In an embodiment, an appropriately conservative estimated bounding box for the primitive is used for this purpose.

In one embodiment, a bounding box that is based on (and corresponds to) the original primitive (the “unclipped” version of the primitive) (that is based on the original (initially-defined) vertices for the primitive (that is to undergo the clipping process)) is used by and for the binning process for a primitive that is to undergo a clipping process. The Applicants have recognised in this regard that, at least in the normal course, any clipping of a primitive should only make the primitive smaller rather than larger, and so using the bounding box for (based on) the original, unclipped primitive will provide an appropriately conservative bounding box to be used by the binning process.

In an embodiment, the bounding box that is used for a primitive that is to undergo the clipping process for the binning process can also, and in an embodiment does also, take account of a clip plane (and in an embodiment of one or more of the clip planes) defined for the render output.

The Applicants have recognised in this regard, that a clipped primitive should not extend outside the clip planes defined for a render output, such that it again will be an appropriately conservative estimate of the bounding box for a primitive if the bounding box is constrained to not extend outside a clip plane defined for the render output.

Thus, in an embodiment, the bounding box that is used for a primitive that is to undergo the clipping process for the binning process is based on a bounding box for (based on the vertices for) the originally defined (unclipped) primitive, and one or more of the clip planes defined for the render output (and in an embodiment constrained to be within one or more of the clip planes defined for the render output).

It would be possible in this case to base the bounding box for a primitive that is to undergo the clipping process on only some but not all of the clip planes defined for the render output, or based on all of the clip planes defined for the render output, as desired. This may depend, for example, upon how accurate it is desired for the binning process to be, as against any extra processing required to determine a better estimate of the bounding box for a primitive.

For example, the bounding box for a primitive could take account of (only) the view port clip planes, but not any user defined clip planes, or vice-versa. The bounding box could also or instead be based (only) on any clip planes that it has been determined that the primitive could be clipped by (e.g. when determining whether the primitive could be clipped by a clip plane defined for the render output) (but not any clip planes that it has been determined that the primitive could not be clipped by).

Thus in an embodiment, the bounding box that is used for the binning process for a primitive that is to undergo a clipping process is based on the bounding box for the original (unclipped) version of the primitive (the vertices for that primitive), but with that bounding box then further being constrained (if necessary) to lie inside a, and in an embodiment plural, and in an embodiment all, of the clip planes defined for the render output.

Correspondingly in an embodiment, the bounding box that is used for the binning process for a primitive that is to undergo a clipping process is based on the bounding box for the original (unclipped) version of the primitive, but with that bounding box when it crosses a clip plane or clip planes defined for the render output being generated (and that is being considered for the purpose of generating the bounding box for the primitive) then being (further) constrained to lie within the clip plane or clip planes in question.

The binning process may process a primitive that is to undergo a clipping process for a render output based on the estimate of the effect of any clipping of the primitive against clip planes defined for the render output (using an appropriate bounding box for the primitive) in any suitable and desired manner.

This operation in an embodiment takes account of, and is based on, an estimated number of vertices and/or primitives that could result for a primitive as a result of the clipping process for that primitive.

In an embodiment the binning process generates the binning data structures based on the estimate of the effect of any clipping of the primitive against clip planes defined for the render output, and in an embodiment taking account of, and based on, an estimated number of vertices and/or primitives that could result for a primitive as a result of the clipping process for that primitive.

In an embodiment, the binning process includes (allocates) (appropriate) entries in the binning data structures that it generates (and, e.g., and in an embodiment, allocates storage space for those entries), based on the estimate of the effect of any clipping of a primitive against clip planes defined for the render output, and in an embodiment taking account of, and based on, an estimated number of vertices and/or primitives that could result for a primitive as a result of the clipping process for that primitive (that it is estimated will result from the primitive as a result of the clipping process).

The binning data structure entries that are allocated/included for a primitive that is to undergo a clipping process are in an embodiment in the form of “placeholder” entries (as the clipping process will not yet actually have been performed for the primitive (prior to the binning process), and so the “true” data (values) for those entries will not yet be known).

This operation may, and in an embodiment does, depend upon the nature of the binning data structures that the binning process generates (is configured to generate).

In the case where the binning process generates lists of primitives and/or packets to be processed for respective regions of a render output, then in an embodiment, the binning process operates to add (include) (placeholder) primitives and/or packets to respective primitive/packet lists based on the estimated effect of the clipping of the primitive against clip planes defined for the render output (and using an appropriate bounding box for the primitive that is to undergo the clipping process, as discussed above).

Thus in this case, the binning process in an embodiment adds as many (placeholder) primitives/packets to the primitive/packet list(s) for a primitive that is to undergo the clipping process as would result according to the estimated effect of the clipping of the primitive against clip planes defined for the render output.

Thus in this case, it is in an embodiment estimated how many primitives and/or vertices could result for the primitive that is to undergo the clipping process as a result of the clipping of the primitive, and then that number of primitives and/or vertices is in an embodiment included (as placeholders) in a primitive list or lists by the binning process when “binning” the primitive that is to undergo the clipping process.

In this case, the primitive/packet lists will be prepared by the binning process based on the estimated (and in an embodiment worst case) clipping result (the binning process will “bin” the estimated (e.g. worst case) clipping result).

In the case where the binning process generates bounding box data structures (and in an embodiment hierarchies of bounding boxes) (for use then to determine which packets/primitives need to be processed for a respective region of the render output being generated), then in an embodiment, the binning process in an embodiment includes in the appropriate binning data structure(s) an appropriate bounding box or bounding boxes for a primitive that is to undergo the clipping process (in an embodiment determined as discussed above) and (placeholder) entries based on an estimated number of primitives/vertices (and/or for attribute(s) for those vertices) that could result from the clipping process.

In an embodiment, where the binning process operates to generate respective (primitive) packets that each store data for a set of one or more primitives (and in an embodiment for a set of plural primitives) to be rendered, the binning process operates to generate such packets for a primitive that is to undergo a clipping process for a render output based on the estimate of the effect of any clipping of the primitive against clip planes defined for the render output, and in an embodiment taking account of, and based on, an estimated number of vertices and/or primitives that could result for the primitive as a result of the clipping process for the primitive.

In an embodiment the binning process includes (adds) appropriate (placeholder) entries in a (primitive) packet for the primitives, and/or vertices, that it is estimated could result from a primitive as a result of the clipping process.

Thus in in an embodiment, it is estimated how many primitives and/or vertices could result for a primitive as a result of the clipping of the primitive, and then (placeholder) entries (storage space) for that number of primitives and/or vertices and/or for attributes for that number of vertices are included in (allocated for) a (primitive) packet or packets by the binning process when “binning” the primitive that is to undergo a clipping process.

Thus, where the (primitive) packets generated by the binning process store one or more attributes, such as positions and/or other (non-position) varyings, for a set of (in an embodiment plural) vertices for the primitives that a packet relates to, in the case of a primitive that is to undergo a clipping process, the binning process in an embodiment includes (adds) appropriate (placeholder) entries (allocates appropriate space) for storing the desired attributes for vertices that may result from the clipping process in a (primitive) packet for the primitive, in an embodiment based on the number of vertices that it is estimated there could be for the primitive as a result of the clipping process.

In an embodiment, the binning process also sets aside (allocates) appropriate entries/space for other primitive data that may need to be included in the binning data structure (e.g. a primitive packet for the primitive that is to undergo the clipping process), such as for indicating a bounding box for the primitive, one or more identifiers relating to the primitive, and for indicating the vertices of the primitive (e.g. for commands for indicating this information).

In an embodiment, an indication that a primitive is a “clipped” primitive, or an entry (space) for an indication that a primitive is a “clipped” primitive, is also included in a binning data structure(s) (e.g. packet) by the binning process for a primitive that is to undergo the clipping process.

Once a primitive that is to undergo a clipping process has been processed by the binning process (as discussed above), then clipping of the primitive is performed (the primitive is subjected to a (the) clipping process).

The clipping process for a primitive can be performed in any suitable and desired manner. It is in an embodiment performed based on and in accordance with the normal clipping process for the graphics processing pipeline and graphics processing system in question.

Thus, in an embodiment, the clipping process will operate to test the primitive against the clip planes defined for the render output, and, where appropriate, clip the primitive against the clip plane(s), e.g. and in an embodiment such that when at least part of a primitive to be rendered falls behind a clip plane, the at least part of the primitive to be rendered that falls behind the clip plane is clipped to the clip plane.

(Correspondingly, in an embodiment, where the clipping process determines that a primitive should be entirely culled (“clipped away”) as a result of clipping against a clip plane(s) defined for the render output, the clipping process culls the primitive from further processing.)

Thus, in an embodiment, the clipping process will operate to test the primitive against one or more of the clip planes defined for the render output, and generate zero or more new vertices, and/or zero or more new primitives, corresponding to and for the primitive being processed as a result of any clipping that the primitive undergoes.

The clipping process in an embodiment also generates one or more (e.g. any required) attributes for a (and each) new vertex that is generated as a result of the clipping of a primitive, such as, and in an embodiment, positions (coordinates), or both positions (coordinates) and non-position attributes (e.g. colours, transparency, etc.), for the (and each) new vertex that is generated as a result of the clipping.

The clipping process may also, and in embodiments does also, output one or more or all of the original, initially defined vertices (and their appropriate attributes) for a primitive where, for example, and in an embodiment, the clipping process determines that one or more or all of the initially defined vertices of the primitive will still be required for processing the primitive when performing the rendering processing for the primitive.

In this case, the clipping process in an embodiment operates to discard any of the initially defined vertices for a primitive that the clipping process determines will not in fact be required when processing the “clipped” version of the primitive (but will output any of the initially defined vertices that will be required when processing the “clipped” version of the primitive).

The Applicants have recognised in this regard, that the result of the clipping process for a primitive may be the generation of one or more new vertices for the primitive (e.g. at the intersection points of the primitive will the clip plane), but also that after clipping one or more of the original (initially defined) vertices for the primitive may still be required (but one or more of the initial vertices for the primitive may be discarded as a result of the clipping process).

Accordingly, the clipping process in an embodiment generates as its output all the required vertices for processing the “clipped” version of the primitive, which may, and in an embodiment does, comprise a combination of new vertices that result from the clipping process, and one or more of the original (initially defined) vertices for the primitive.

The clipping process correspondingly in an embodiment determines which (if any) of the original (initially defined) vertices are still required for the primitive, and outputs those vertices (their attributes), but, correspondingly, does not output any of the initially original vertices for a primitive that are determined as no longer being required by the clipping process.

Alternatively, the initially defined vertices for a primitive could otherwise be provided to the rendering process, with the clipping process then only generating and outputting any new vertices (their attributes) that are generated as a result of the clipping of a primitive.

The overall clipping process can be configured and performed as desired. For example, it would be possible for the clipping process to generate all the attributes (including non-position attributes) for any new vertices that are generated as part of the clipping process.

Alternatively, the clipping process that determines what new vertices are required as a result of the clipping could determine only some but not all attributes, such as positions (coordinates) only, for those new vertices, with the generation of other attributes (e.g. non-position attributes) for any new vertices generated as a result of the clipping of a primitive being deferred until later in the sequence of graphics processing (such as, and in an embodiment, being done as part of the rendering process).

Other arrangements would, of course, be possible.

The clipping processing for a primitive that is to undergo clipping processing for a render output can be performed by any suitable and desired element (circuit) of the graphics processor. For example, the graphics processor may have a (substantially) fixed function unit (circuit) that is provided and used for this purpose.

In an embodiment, the clipping process for a primitive is performed by executing an appropriate (shader) program or programs (a “clip” shader) for the primitive in question. Such a “clip shader” may be, and is in an embodiment, executed by an appropriate programable processing unit (execution engine) of a programable processing core (shader core) of the graphics processor.

The clipping processing of primitives that are to undergo a clipping process for a render output is in an embodiment configured and performed such that plural primitives can, and in an embodiment do, undergo their clipping processing in parallel.

Correspondingly, in an embodiment, the clipping processing for primitives can be and is in an embodiment started without the need to wait for the clipping processing for a preceding primitive to be completed.

The clipping process for a primitive that undergoes the clipping process will, and in an embodiment does, as discussed above, (potentially) generate further data, and in particular new vertices (and attributes for those vertices) where a primitive is determined to actually need clipping by a clip plane defined for the render output and the result of that clipping is a new vertex and/or a new primitive corresponding to (relating to) the primitive that is undergoing the clipping process.

Similarly, the clipping process for a primitive that undergoes the clipping process will, and in an embodiment does, output zero or more of the original (initially defined) vertices for the primitive (attributes for those vertices).

Thus, once a primitive has undergone the clipping process, the result of the clipping process for that primitive may, and in an embodiment does, comprise zero or more new (additional) vertices (one or more attributes for those vertices), zero or more of the original vertices (one or more attributes for those vertices) for the primitive, and/or zero or more new (additional) primitives, corresponding to the primitive that has undergone the clipping process.

The result of the clipping process, such as, and in an embodiment, the zero or more new vertices (their attributes), zero or more original vertices, and zero or more new primitives, corresponding to a clipped primitive, generated as a result of the clipping process for a primitive, will then be used by and for the rendering process (together with the binning data structures generated by the binning process) for processing (rendering) the “clipped” primitive for the render output.

Thus, in the case where the clipping process for a primitive generates one or more new vertices and/or one or more new primitives for a primitive, the rendering process will use and process those new vertices, for example and in an embodiment, the corresponding attributes for those vertices, and/or the one or more new primitives, when performing the rendering processing for the primitive that has undergone the clipping process.

The result of the clipping process for a primitive, such as any new vertices (and their attributes), any of the original vertices (and their attributes), and/or any new primitives, can be conveyed to the rendering process in any suitable and desired manner. For example, this information could be provided as a separate data structure or structures to the rendering process.

In an embodiment, the result of the clipping process for a primitive is provided to the rendering process as part of and in the binning data structures that are provided to the rendering process.

Thus, in an embodiment, the result of the clipping process for a primitive is added to and included in a binning data structure or structures that has been generated by the binning process (and in an embodiment in a binning data structure or structures that the primitive that has undergone the binning process was included in by the binning process prior to undergoing the clipping process). In an embodiment this comprises including any and all new vertices (and/or one or more attributes for those vertices), any and all required original vertices (and/or one or more attributes for those vertices), and/or any and all new primitives in the (appropriate) binning data structure or structures.

The information that is included in a binning data structure or structures to convey the result of the clipping process for a primitive to the rendering process may, and in an embodiment does, depend upon the nature of the binning data structures and the data that they store. For example, where the binning data structures comprise lists of primitives/packets to be processed for respective rendering tiles or sets of rendering tiles, the necessary information for any vertices and/or primitives that are a result of the clipping process for a primitive are in an embodiment appropriately included in those lists.

In the case where the binning data structures comprise bounding boxes, such as and in an embodiment hierarchies of bounding boxes, then again the result of the clipping processing is in an embodiment included in those data structures appropriately.

Thus, in the case where the bounding box data structures (include packets that) store attributes of vertices for primitives that they relate to, the (appropriate) attributes for any new vertices that are generated as a result of the clipping process for a primitive are in an embodiment included in the binning data structures accordingly.

Similarly, in the case where the bounding box data structures (include packets that) store attributes of vertices for primitives that they relate to, the (appropriate) attributes for any original vertices that are not discarded as a result of the clipping process for a primitive are in an embodiment included in the binning data structures accordingly.

As discussed above, in an embodiment, the binning process is configured to allocate (placeholder) entries in the binning data structures that it generates for a primitive that is to undergo a clipping process (based on an estimated effect of any clipping of the primitive in question). Thus in an embodiment, the result of the clipping processing for a primitive is included in a binning data structure by including the necessary clipping result data, such as attributes for new vertices that are generated as a result of the clipping process, and/or attributes for original vertices that are not discarded as a result of the clipping process, in the appropriate (placeholder) entries included (allocated) in the previously prepared binning data structures.

Thus, for example, and in an embodiment, where it is estimated that the clipping process could result in a given number of vertices for a primitive, the binning process will allocate an appropriate placeholder entry or entries in a binning data structure or structures for (one or more attributes for) that estimated number of vertices, the clipping process will then be performed for the primitive, and the relevant data (e.g. attribute) for the vertices needed for the primitive after the clipping process will be included in the previously allocated placeholder entries for the vertices (attributes) in the binning data structure(s).

The Applicants have further recognised in this regard that the estimate of the effect of the clipping process on a primitive, e.g. in terms of the number of vertices and/or primitives that may result as a result of the clipping process for the primitive, may, as discussed above, overestimate the number of vertices and/or primitives that will result for a primitive as a result of the clipping process.

The Applicants have correspondingly recognised in this regard that where the binning process allocates placeholder entries in the binning data structures for data corresponding to the results of the clipping process based on the estimate of the effect of the clipping process for the primitive, and the estimate of the effect of the clipping process for a primitive turns out to be an overestimate of the number of vertices and/or primitives that was produced as a result of the clipping process for the primitive, then there will, in effect, be placeholder entries in the binning data structures for clipping process results (such as for attributes for additional vertices and/or primitives) that are not in fact generated as a result of the clipping process. It would accordingly be desirable in this case to be able to indicate that those placeholder entries are “invalid” (do not contain valid clipping result data, such as additional vertex attribute data), so that the rendering process can “ignore” those placeholder entries in the binning data structures.

Thus, in an embodiment, any space ((placeholder) entries) allocated in a binning data structure for a primitive that is to undergo a clipping process that are not in fact needed to store data that results from the clipping process for a primitive are in an embodiment appropriately indicated as being invalid (as not containing any valid data) (as not to be used). This may be done in any suitable and desired manner, for example by setting an appropriate flag for the “invalid” (placeholder) entries. In an embodiment, this is done by setting the data values in the (placeholder) entries to “not a number” (NaN) (for the graphics processing system in question), so that the rendering processing can recognise that those entries do not contain valid data. Other arrangements would, of course, be possible.

Thus in an embodiment, the clipping process generates data (e.g. one or more attributes (values)) for one or more vertices for a primitive, and stores the data (e.g. one or more attributes) for those vertices in (placeholder) entries (previously allocated space) in a (previously prepared) binning data structure.

Correspondingly, in an embodiment, the clipping process provides for (e.g. in) any (placeholder) entries (space) in a binning data structure for vertices (e.g. their attributes) for a primitive that is undergoing the clipping process that the clipping process determines are not in fact required for the primitive (for which the clipping process does not generate data), an indication that those entries in the binning data structure are not valid.

In an embodiment, the clipping process also updates (includes) in a binning data structure any other information that it is desirable to update/include for the primitive that has undergone the clipping process. For example, where the binning process allocates appropriate entries (space) for other information, such as a bounding box, and/or identifiers, etc., for a primitive that is to undergo a clipping process, that information can be, and is in an embodiment, appropriately populated in the binning data structure (e.g. packet) by the clipping process.

In an embodiment, the clipping process also adds an appropriate indication that the primitive has undergone a clipping process in the appropriate binning data structure or structures (where such an indication is not already present for the primitive).

In the case of a bounding box for a primitive that has undergone the clipping process, it would be possible, if desired, to include and/or update a bounding box that is stored for a primitive that has undergone the clipping process in a binning data structure based on the result of the clipping process for the primitive (and in one embodiment, that is what is done).

However, the Applicants have recognised that the bounding box that was used when initially binning a primitive (before it undergoes any clipping process) will still be suitable as an appropriately conservative bounding box for determining the rendering tiles that the primitive should be processed for, such that it is not necessary for the bounding box for a primitive that undergoes a clipping process to be based on/updated based on the results of the clipping processing for the primitive for the primitive to still be able to be processed for the correct rendering tile(s).

Thus, in an embodiment, the bounding box for a primitive that undergoes the clipping process and/or (and in an embodiment and) any additional bounding boxes relating to the primitive, is/are in an embodiment not based on/modified (updated) based on a result of the clipping processing for the primitive. Correspondingly, in an embodiment, no new or additional bounding boxes are generated as a result of the clipping process for a primitive.

Thus the bounding box that is used for a primitive that has undergone the clipping process (and, e.g., included in a binning data structure, e.g. packet, for the primitive) is in an embodiment the bounding box that was used when performing the binning process for the primitive (and is not a bounding box that takes account of the result of the clipping processing for the primitive).

Correspondingly, the bounding box used for a primitive for the binning process prior to the primitive undergoing the clipping process is in an embodiment retained and used as the bounding box for the primitive when determining the rendering tiles that the primitive (and any additional primitives relating to the primitive generated as a result of the clipping process) should be processed for.

Once the clipping processing has been completed for a primitive (and, e.g., the binning data structure(s) have been correspondingly updated), the primitive can be rendered.

In an embodiment, the clipping processing for all of the primitives that are to undergo a clipping process for the render output in question is completed (and the binning data structures correspondingly updated) before the rendering processing for the render output is begun.

In the case where it is other than (it is not) determined that a primitive should undergo a clipping process for the render output, then the primitive can be handled in the normal manner for the graphics processor and graphics processing pipeline being executed in question. For example, and in an embodiment, the primitive can be, and is in an embodiment, simply processed by the binning stage in the normal manner to be included in an appropriate binning data structure or structures, and then does not undergo any clipping process, but rather is subjected to rendering processing in the normal manner when the tiles for the render output are being rendered.

Although the technology described herein has been described above with particular reference to the processing in respect of a given (single) primitive being considered for a render output, it will be appreciated that the processing in the manner of the technology described herein should be, and is in an embodiment, performed for plural primitives, and in an embodiment for each primitive of the primitives to be rendered for a render output.

The rendering processing for primitives that have undergone the clipping process (and for primitives that have not undergone the clipping process) can comprise any suitable and desired rendering process that a graphics processing pipeline can perform.

The rendering will be performed on a tile by tile basis (as the graphics processor is executing a tile based graphics processing pipeline), and so, accordingly, the rendering process will, and in an embodiment does, use the binning data structures generated by the binning stage (and updated by the clipping processing where necessary) to identify geometry, e.g. packets/primitives, to be processed for a (and each) tile to be rendered, and then render the tile accordingly.

The rendering processing that is performed for a tile can be any suitable and desired rendering processing that may be performed by a graphics processor and a graphics processing pipeline. Thus this may comprise, for example, rasterising primitives to fragments and fragment shading the fragments, and/or performing ray tracing processes, etc..

The rendering process can be, and is in an embodiment, performed in the normal manner for the graphics processor and graphics processing pipeline in question.

The rendering process in an embodiment generates appropriate rendered output data values (e.g. RGB or RGBA values) for a primitive and for the tile of the render output that is being rendered. The output rendered data may then be appropriately written out, e.g. to memory, for the render output in question.

Other arrangements would, of course, be possible.

Subject to the particular operation in the manner of the technology described herein in relation to the (potential) clipping of primitives, the graphics processor and graphics processing pipeline can otherwise operate in any suitable and desired manner, for example, and in an embodiment, in the normal manner for the graphics processor and graphics processing pipeline in question.

Correspondingly, as well as the particular elements, stages, circuits, etc., described above with particular reference to the operation in the manner of the technology described herein, the graphics processor and graphics processing pipeline may otherwise include any suitable and desired elements, circuits, processing stages, etc., that a graphics processor and graphics processing pipeline may normally comprise.

Thus, the graphics processor and graphics processing pipeline may, and in an embodiment does, also comprise any other suitable and desired processing stages (circuits) that a graphics processor and processing pipeline may contain, such as a depth (or depth and stencil) tester(s) (circuit(s)), a blender (blending circuit), a tile buffer or buffers, a write out unit (circuit), etc..

It will furthermore be appreciated that the graphics processor of the technology described herein may be part of an overall graphics processing system that includes, e.g., and in an embodiment, a host processor (e.g. CPU) that, e.g., executes applications that require (graphics) processing by the graphics processor. The host processor will send appropriate commands and data to the graphics processor to control it to perform graphics processing operations and to produce graphics processing output required by applications executing on the host processor. To facilitate this, the host processor should, and in an embodiment does, also execute a driver for the graphics processor. The host processor may also execute a compiler or compilers for compiling programs to be executed by (e.g., a programmable processing stage (shader) of the) graphics processor.

The graphics processor may also comprise, and/or be in communication with, one or more memories and/or memory devices that store the data described herein, and/or the output data generated by the graphics processor, and/or store software (e.g. programs) for performing the processes described herein. The graphics processor may also be in communication with a host microprocessor, and/or with a display for displaying images based on the data generated by the graphics processor.

The technology described herein can be used for all forms of output that a graphics processor and graphics processing pipeline may be used to generate. For example, the graphics processor may generate frames for display, render to texture outputs, etc.. The output data values from the processing are in an embodiment exported to external, e.g. main, memory, for storage and use, such as to a frame buffer for a display.

The technology described herein can be implemented in any suitable system, such as a suitably operable micro-processor based system. In some embodiments, the technology described herein is implemented in a computer and/or micro-processor based system.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein can be implemented in hardware or software, as desired. Thus, for example, unless otherwise indicated, the various circuitry, functional elements, stages, and units, of the technology described herein may comprise a suitable processor or processors, controller or controllers, functional units, circuitry, circuits, processing logic, microprocessor arrangements, etc., that are configured/operable to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuitry (circuit) of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc..

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

Embodiments of the technology described herein will now be described.

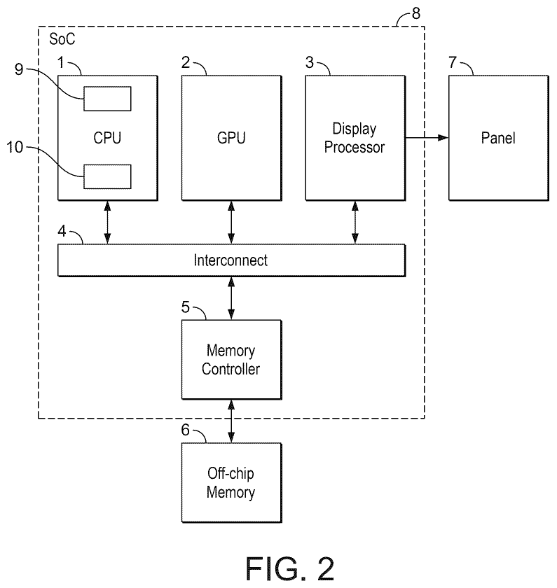

FIG. 2 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 2, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

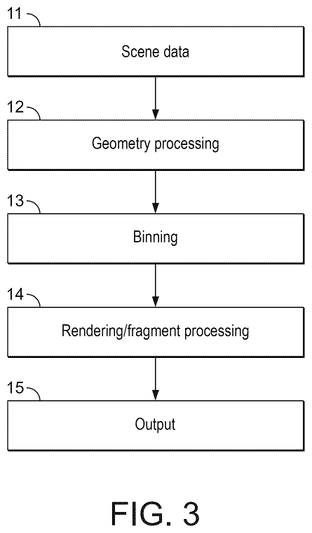

FIG. 3 shows schematically the processing sequence of the graphics processing pipeline executed by the graphics processor 2 when generating an output in the present embodiments.

FIG. 3 shows the main elements and pipeline stages. As will be appreciated by those skilled in the art there may be other elements of the graphics processor and processing pipeline that are not illustrated in FIG. 3. It should also be noted here that FIG. 3 is only schematic, and that, for example, in practice the shown pipeline stages may share significant hardware circuits, even though they are shown schematically as separate stages in FIG. 3. It will also be appreciated that each of the stages, elements and units, etc., of the processing pipeline as shown in FIG. 3 may, unless otherwise indicated, be implemented as desired and will accordingly comprise, e.g., appropriate circuitry, circuits and/or processing logic, etc., for performing the necessary operation and functions.

As shown in FIG. 3, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in an embodiment, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry processing stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices (varyings/varying shading). It would also be possible for some or all the varying shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing has been performed, there is then, in the present embodiments, as shown in FIG. 3, a binning/tiling stage 13. (It is assumed in this regard that the graphics processor 2 in the present embodiments is a tile-based graphics processor and so generates respective output tiles of an overall output (e.g. frame) to be generated separately to each other, with the set of tiles for the overall output then being appropriately combined to provide the final, overall output.)

The binning process operates to generate appropriate data structures for determining which primitives need to be processed for respective rendering tiles of the output being generated. For example, it may sort the primitives into appropriate primitive lists, which indicate the primitives to be processed for respective tiles or sets of tiles. Alternatively, it may generate other data structures, such as hierarchies of bounding boxes, that can then be used at the rendering/fragment processing stage to identify those primitives that need to be processed for a respective tile.

The binning/tiling process 13 may also cull primitives that are not visible (e.g. that fall outside the view frustum, and/or based on the facing direction of the primitives).

As part of the geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

Once the binning/tiling process has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing can comprise any suitable and desired rendering and fragment processing operations that may be performed. Thus it may comprise, for example, first rasterising primitives to be processed for a tile to fragments, and then processing those fragments accordingly (e.g., and in an embodiment, by performing appropriate fragment shading of the fragments). The rendering/fragment processing may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc..

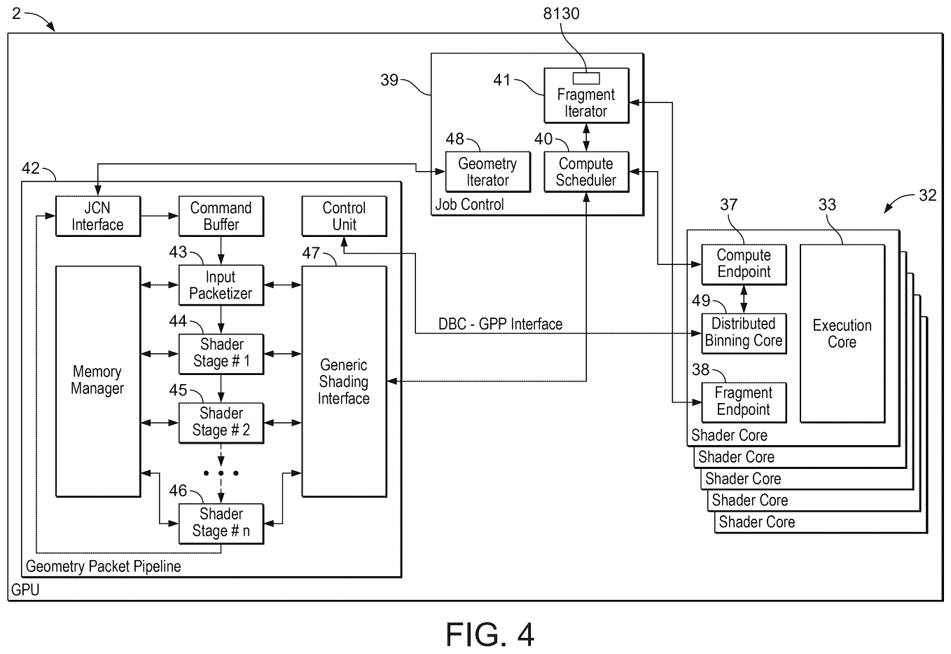

FIG. 4 shows an embodiment of a graphics processor (GPU) 2 that can execute a graphics processing pipeline of the form shown in FIG. 3, and that can be operated in the manner of the technology described herein.

As shown in FIG. 4, the graphics processor 2 comprises a plurality of processing (shader) cores 32 which are each operable to execute (shader) programs to perform processing operations. As shown in FIG. 4 each shader core 32 to facilitate this comprises a programmable execution unit (execution core) 33 that is operable to execute program instructions to perform processing operations.

In the present embodiments, the shader cores 32 are operable to execute both “compute” shader programs (to perform so-called compute shading) and fragment shader operations. Thus as shown in FIG. 4, each shader core 32 comprises an appropriate compute endpoint 37 and fragment endpoint 38 that act as the control interface for performing compute shading and fragment processing, respectively, and that will, for example, and in an embodiment, trigger the execution core 33 to execute the appropriate compute shading or fragment shading tasks, as required.

As shown in FIG. 4, the compute endpoint 37 and fragment endpoint 38 receive appropriate processing tasks from a job control unit 39 of the graphics processor 2, which job control unit 39 includes an appropriate compute scheduler 40 and fragment iterator 41 for distributing processing jobs that the job controller 39 receives as appropriate processing jobs to the shader cores 32.

As discussed above, when performing graphics processing, there will typically be an initial geometry processing stage that determines the vertex and other data that is necessary for generating the graphics processing output in question, which will then be followed by a rendering/fragment processing stage for processing (rendering) that geometry.

In the present embodiments, the geometry processing is performed, as shown in FIG. 4, by a geometry packet pipeline 42 of the graphics processor 2. This geometry packet pipeline is operable to trigger the performance of one or more “geometry” shader stages (which shader stages themselves will be executed by the shader cores 32, under the control of the geometry packet pipeline 42).

For example, as shown in FIG. 4, the geometry packet pipeline 42 comprises an input packetizer 43 that can trigger position shading and vertex shading by the shader cores 32. It also includes further shader stage circuits 44, 45, 46 that are operable to trigger compute shaders for performing geometry processing, such as task shaders, mesh shaders, tessellation shaders, etc. (which again will be executed by the shader cores 32).

As shown in FIG. 4, the geometry packet pipeline 42 has an appropriate interface 47 to the compute scheduler 40 of the job control unit 39, via which it can control and trigger the performance of appropriate geometry shading operations by the shader cores 32.

The overall operation of the geometry packet pipeline 42 is controlled by the job control unit 39 (by a geometry iterator 48 of the job control unit 39) which distributes the appropriate geometry processing jobs and tasks to the geometry packet pipeline 42.

The graphics processor 2 of FIG. 4 is configured to perform rendering in a tile-based manner (as discussed above). To facilitate this, as shown in FIG. 4, each shader core 32 also includes a distributed binning core 49 that is operable to generate appropriate data structures for determining which primitives need to be processed for respective rendering tiles of the output being generated.

In the present embodiments, the distributed binning cores 49 generate hierarchies of bounding boxes for primitives and primitive packets (that contain primitives to be rendered) (which are then used at the rendering/fragment processing stage to identify those primitives that need to be processed for a respective tile).

The distributed binning cores 49 may also cull primitives that are not visible (e.g. that fall outside the view frustum, and/or based on the facing direction of the primitives).

The distributed binning cores 49 can operate in any suitable and desired manner for this purpose.

The distributed binning cores 49 of the shader cores 32 may trigger vertex shading, such as varying shading, as part of their operation (e.g. where varying shading was not performed by the input packetizer as part of the input packetizer 43 operation).

In the present embodiments, the rendering/fragment processing is performed by executing appropriate fragment processing operations on a shader core 32 under the control of the fragment endpoint 38. To facilitate this, the fragment endpoint 38 of each shader core is operable to trigger appropriate fragment shader operation by a shader core.

As will be appreciated from the above, in operation of the present embodiments, the geometry packet pipeline 42 that performs the geometry processing will generate appropriate geometry data, such as (transformed) vertex positions, vertex varyings, and primitive attributes, which data will then be used, for example, by the binning/tiling processing and rendering/fragment processing of the later stages of the graphics processing pipeline.

In the present embodiments, the geometry packet pipeline 42 operates to generate respective geometry packets containing the data that it generates. In the present embodiments, those geometry packets are then processed by the distributed binning cores 49 to generate corresponding primitive packets, which primitive packets are then used by the fragment processing (fragment shaders) 52.

Thus, in the present embodiments, the geometry packet pipeline 42 will generate geometry packets that store attributes for vertices and primitives, which geometry packets will then be read and used by the distributed binning cores 49.

Correspondingly, the distributed binning cores 49 will generate appropriate primitive packets storing attributes for vertices and primitives, which primitive packets will then be read and used by the fragment processing 38.

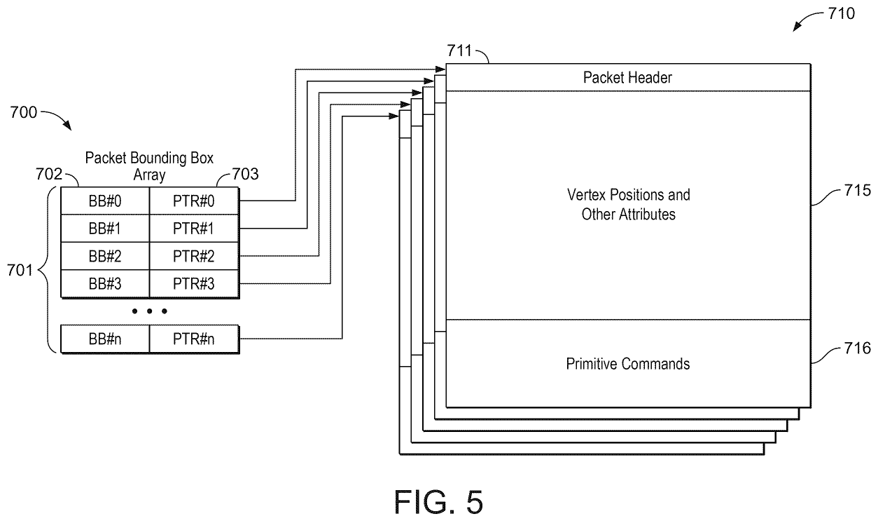

FIGS. 5 and 6, show, by way of example, a bounding box hierarchy binning data structure that may be generated in the present embodiments.

As shown in FIG. 5, the lowest level of the bounding box hierarchy comprises a packet bounding box array 700 that includes a number of entries 701 that each include a respective pointer 703 pointing to a respective packet 710 in memory, and a bounding box (bounding box information) 702 for the packet in question.

FIG. 5 also shows the memory layout and content for an exemplary packet 710 that may have been generated. As illustrated in FIG. 5, in the present embodiments, each packet 710 may include header information 711 and body information comprising vertex attribute data (such as positions and other attributes) 715 for the vertices that the packet contains, and a set of primitive commands 716 that may indicate for each primitive the packet relates to (stores) one or more of: one or more identifiers for the primitive; a bounding box for the primitive; and the vertices for the primitive (e.g. where the vertices and attributes for the primitive are located in the packet).

Other arrangements for a packet would, of course, be possible.

As shown in FIG. 6 one or more further bounding box hierarchy levels are also generated.

As illustrated in FIG. 6, a bounding box hierarchy array 1100 may be maintained, with each entry of the array comprising a pointer pointing to an array defining bounding boxes for a respective level of the bounding box hierarchy. As illustrated in FIG. 6, in this embodiment, the first entry of the bounding box hierarchy array 1100 points to the lowest level packet array 700 shown in FIG. 5.

A higher level of the bounding box hierarchy may be generated by iterating through the packet array 700 and generating from the packet bounding boxes 702, bounding boxes for groups of, e.g. two, four, eight (or another number), packets. As illustrated in FIG. 6, these (larger) bounding boxes may be stored in entries of higher-level array 1110, wherein each entry of the array 1110 comprises a respective, “higher level” bounding box 1112, and pointers 1113 pointing to the packet array 700 entries for the packet bounding boxes from which the “higher level” bounding box was generated.

Further levels of the bounding box hierarchy may be generated in an analogous manner. For example, FIG. 6 shows a higher-still level of the bounding box hierarchy generated by iterating through array 1110 and generating from the bounding boxes 1112, larger bounding boxes, which are stored in entries of array 1120, wherein each entry of the array 1120 comprises a respective, higher level bounding box 1122, and pointers 1123 pointing to the corresponding next lower level array 1110 entries. Further levels of the bounding box hierarchy may be generated up to a “highest” level which may comprise a single bounding box that encompasses all primitives of all packets, e.g. for the draw call/render output in question.

When using this data structure to identify primitive packets that should be processed for a rendering tile, the tile will first be tested against the higher level bounding boxes 1122 to determine respective groups of primitive packets that (potentially) need to be processed for the tile. Then the tile will be tested against the respective individual packet bounding boxes in the appropriate lower level 700 data structure to identify those primitive packets that should be processed for the tile.

The technology described herein and the present embodiments relate in particular to the handling of clip planes and clipping when performing tile-based graphics processing. As discussed above, in graphics processing, it is typically possible to define both view frustum clip planes, and one or more user-defined clip planes, that the rendering process then has to take account of, and e.g., and in an embodiment, clip primitives to be rendered against.

(In the case of a user-defined clip plane, the vertex shading that is part of the geometry processing will, inter alia, also generate for each vertex defined for the render output a “clip distance”, representing the distance from the vertex to the user-defined clip plane in question.)

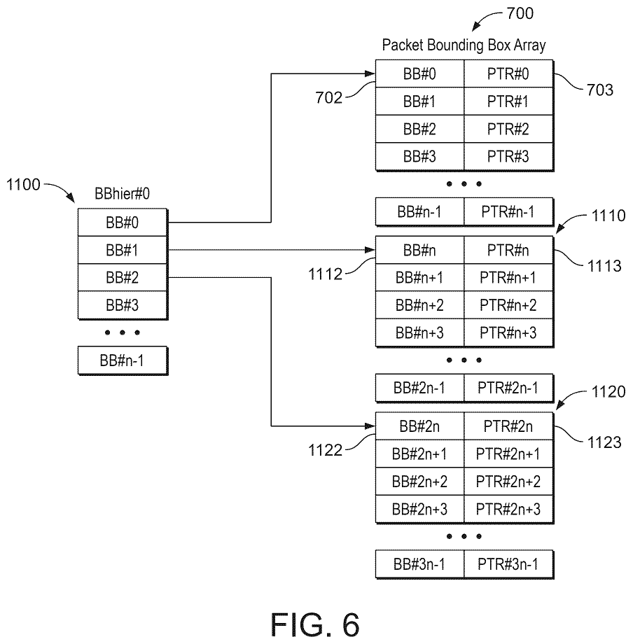

FIG. 7 shows an example of clip planes for a render output 200 to be generated. FIG. 7 shows one user defined clip plane 201 crossing the render output, together with X/Y view frustum clip planes 202 and a guard band 203 defined around the view frustum X/Y clip planes. (The Z axis is not shown in this Example.)

In the present embodiments, the (potential) clipping of primitives is handled by, in accordance with the technology described herein, determining whether a primitive should undergo a clipping process, and, if so, then estimating the effect of clipping on the primitive, and binning the primitive based on the estimated effect of (potential) clipping of the primitive. Then, once the binning process has been performed for the primitive, the primitive undergoes the actual clipping process.

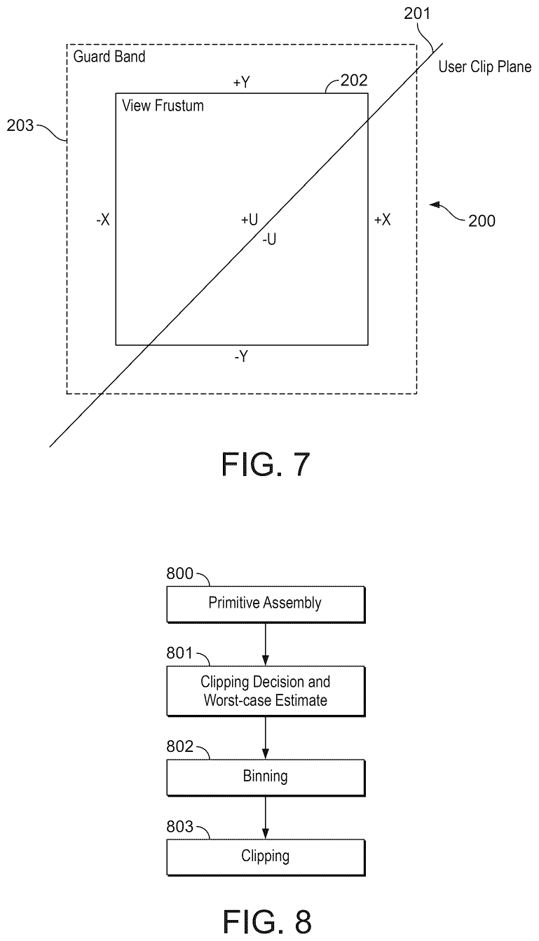

FIG. 8 illustrates this, and shows that after a primitive has been assembled (step 800), it is then determined whether the primitive needs to undergo a clipping process, and if so, an estimate (and in the present embodiment a worst case estimate) of the effect of clipping on the primitive is determined (step 801).

The primitive is then subjected to the binning process based on the (worst case) estimate of the effect of clipping on the primitive (step 802).

Once the binning process has been completed, the primitive can then undergo the (actual) clipping process, to determine the (true) effect of any clipping on the primitive (step 803).

In the present embodiment, the “clipping handling” operation shown in FIG. 8 is performed by the distributed binning cores 49 as part of the binning operation that they perform (step 13 in FIG. 3).

However, other arrangements would be possible, such as some of the processing shown in FIG. 8 being performed, for example, as part of the geometry processing (step 12 in FIG. 3), and/or as part of the rendering/fragment processing (step 14 in FIG. 3).

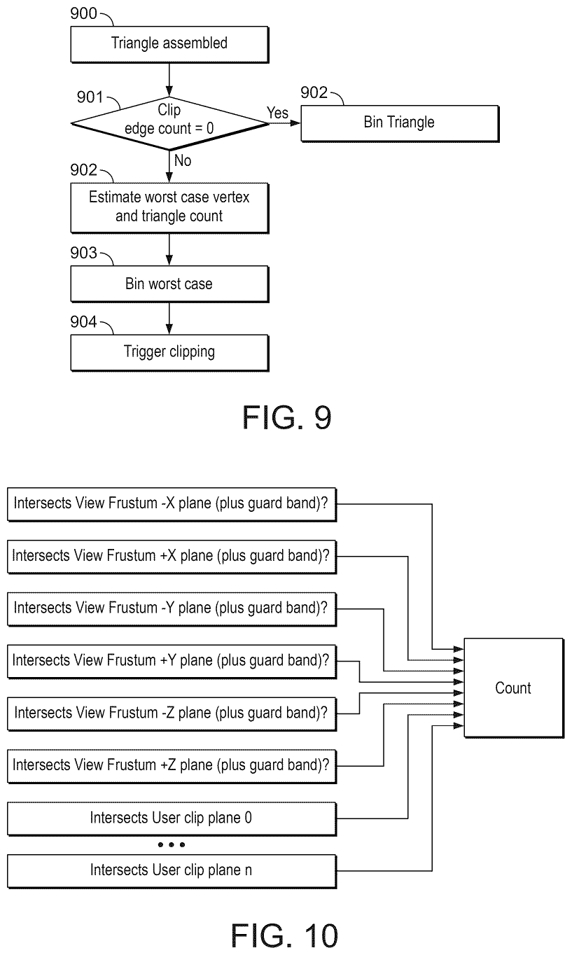

FIGS. 9 and 10 show the clipping handling operation of FIG. 8 in more detail.

As shown in FIG. 9, in the present embodiments, once a triangle (primitive) has been assembled (step 900), it is then determined, as shown in FIG. 10, how many clip planes/edges the primitive (triangle) intersects (step 901).

This test may be performed in any suitable and desired manner. For example, the distributed binning cores 49 could include appropriate fixed function circuits (not shown) for performing a (basic) intersection test to determine whether a primitive (triangle) could intersect a clip plane for the render output being generated or not.

In the case where it is determined that the triangle does not intersect any of the clip planes defined for a render output, then, as shown in FIG. 9, the triangle can simply be “binned” (undergo the binning process) in the normal manner (step 902).

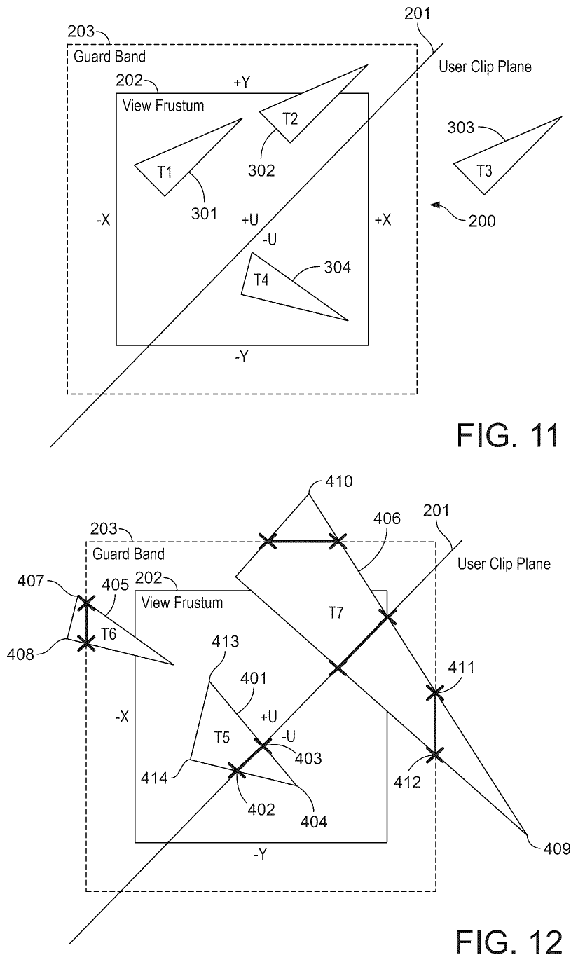

FIG. 11 shows some exemplary triangular primitives for the render output 200 shown in FIG. 7 that will be determined as not needing to undergo a clipping process.

Triangle T1 301 lies entirely within the view frustum clip planes 202 and on he visible side of the user clip plane 201, and so no clipping will be required.

Triangle T2 302 does intersect the view frustum 202, but is inside the guard band 203 (and on the visible side of the user clip plane 201), and so again no clipping is required for that triangle.

Triangle T3 303 lies entirely outside of the view frustum guard band, and so should be discarded without undergoing any clipping.

Triangle T4 304 lies entirely on the non-visible (outside) the user clip plane 201, and so again can be discarded (on the basis of the user defined clip plane) without undergoing any clipping.

On the other hand, in the case where a primitive (triangle) is determined to intersect at least one clip plane for the render output, it is determined that the triangle will need to undergo the clipping process, and in that case, an estimate of the worst case vertex and triangle count that could arise as a result of clipping of the triangle is determined (step 902).

(As discussed above, when a primitive, e.g. triangle, to be rendered is intersected by a clip plane, then that is handled by generating additional vertices at the intersection points, and then (if necessary) processing those vertices and primitives (triangles) containing those vertices accordingly. Thus when a primitive needs to be clipped against a clip plane, there may be new vertices and primitives generated for the clipped primitive. This may be in addition to or instead of (some or all of) the original vertices for the primitive.)

In the present embodiments, the estimated worst case number of vertices and of primitives that could be generated for the primitive as a result of the clipping of the primitive against clip planes defined for the render output is based on the number of clip planes defined for the render output that it is determined that the primitive could be intersected by.

FIG. 12 shows some exemplary primitives for the exemplary render output 200 that will need to undergo a clipping process (and the “worst case” estimate of the effect of that clipping process).

Triangle T5 401 is entirely within the view frustum but intersects the user clip plane. That triangle will accordingly need clipping against the user clip plane 201.

A conservative estimate of the result of clipping of the triangle T5 401 is that clipping could result in four vertices (3+1) and two triangles (1+1) to be processed.

Triangle T6 405 intersects one side of the view frustum guard band and so should undergo a clipping process. Again, a conservative estimate of the effect of that clipping is that it will result in four vertices (3+1) and two triangles (1+1) to be processed.

Triangle T7 406 intersects two edges of the view frustum guard band and the user clip plane 201 and so again should undergo a clipping process. The conservative estimate for this triangle is that the clipping process will result in six vertices (3+3) and four triangles (1+3) needing to be processed.

The binning process then operates to include the triangle that is to undergo the clipping process in appropriate binning data structure(s) based on the estimated vertex and triangle count (step 903).

To perform the binning process for a primitive (triangle) that is to undergo the clipping process, the binning process will, as discussed above, use an appropriate bounding box for the triangle that is to undergo the clipping process. In the present embodiments, an appropriately conservative estimate of a bounding box for a triangle that is to undergo the clipping process is used when binning the triangle.

In the present embodiments, the bounding box for the original triangle (without any clipping) is used for the binning process.

However, it would also be possible to use a better estimate of the bounding box for a potentially clipped triangle if desired. For example, the bounding box could be constrained to not lie outside one or more of the clip planes defined for the render output (as it will be known that a triangle cannot extend outside a clip plane defined for a render output, and so the bounding box for the triangle can correspondingly be constrained to be within some or all of the clip planes, if desired).

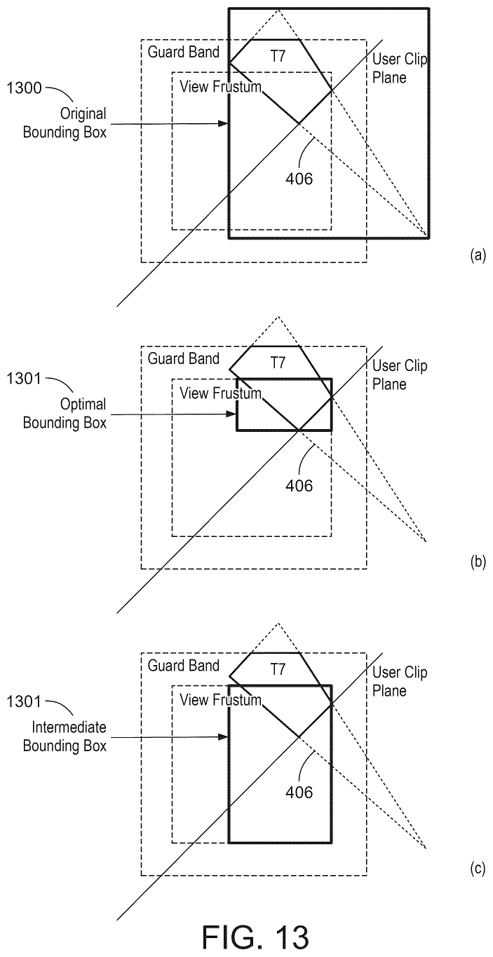

FIG. 13 illustrates this, and shows potential bounding boxes that could be used for the binning process for the triangle T7 406 shown in FIG. 12.

FIG. 13A shows the original bounding box 1300 for the triangle T7 406.

FIG. 13C shows a “better” estimate, “intermediate” bounding box 1301 for the triangle T7 406 in which the bounding box is constrained to lie within the view frustum.

FIG. 13B shows for comparison purposes the optimal bounding box 1302 for the triangle T7 406 based on the actual positions of the clipped vertices for the triangle T7 406 that result from the clipping process (in this example).

As discussed above, in the present embodiments, the binning process generates appropriate (primitive) packets that include for a primitive that is included in a packet, vertex attribute data for the vertices of the primitive, and one or more primitive commands that indicate, e.g. an identifier(s) for the primitive, a bounding box for the primitive, the vertices for the primitive, etc., together with an appropriate hierarchy of bounding box data structures.

Accordingly, when the binning process processes a primitive that is to undergo a clipping process, it will allocate space (entries) for this information for the primitive that is to undergo the clipping process in a (primitive) packet appropriately.

To do this, the binning process includes (adds) (appropriate) placeholder entries in the primitive packet (and allocates storage space for those placeholder entries) for the primitive commands for the primitive that is to undergo the clipping process, and for attributes for vertices that may result from the clipping process for the primitive, based on the estimated number of vertices that could result (need to be processed) for the primitive as a result of the clipping process for that primitive.

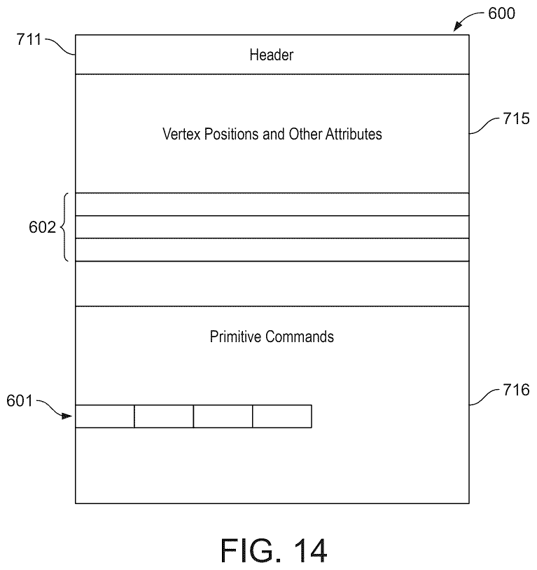

FIG. 14 illustrates this, and shows an exemplary binning data structure 600 that may be generated by the binning process including entries for a primitive that is to undergo the clipping process.

As shown in FIG. 14, and as discussed above, the binning process will include for a primitive that is to undergo a clipping process appropriate “placeholder” entries 601 for the required primitive commands for the primitive that is to undergo the clipping process, and also an allocation of placeholder entries (space) 602 for the attributes for the vertices that it is estimated could result as a result of the clipping process for the primitive.

As shown in FIG. 14, in the present embodiment, the placeholder entries 602 for the attributes for vertices that may result as a result of the clipping process are allocated in the vertex positions and other attributes part 715 of the packet).

Other arrangements would, of course, be possible.

The binning process will also operate to, where necessary, update any higher level bounding boxes in the binning data structures that it is generating based on the bounding box that is used for the primitive that is to undergo the culling process.

Once the primitive (triangle) that is to undergo the clipping process has been binned, the actual clipping process for the triangle is then triggered and performed (step 904).

In the present embodiments, the clipping process operates to test the primitive against the clip planes defined for the render output, and, where appropriate, clip the primitive against the clip plane(s), such that when part of a primitive to be rendered falls behind a clip plane, the part of the primitive to be rendered that falls behind the clip plane is clipped to the clip plane, and zero or more new vertices, and zero or more new primitives, corresponding to and for the primitive being “clipped”, will be generated.

The clipping process also generates any required attributes for a (and each) new vertex that is generated as a result of the clipping of a primitive, such as, and in an embodiment, both positions (coordinates) and non-position attributes (e.g. colours, transparency, etc.).

The overall clipping process can be configured and performed as desired. For example, it would be possible for there to be a single clipping process that generates all the attributes (including non-position attributes) for any new vertices that are generated as part of the clipping process.

Alternatively, there could be a clipping process that determines what new vertices are required as a result of the clipping and determines positions (coordinates) only for those new vertices, with the generation of other attributes (e.g. non-position attributes) for any new vertices generated as a result of the clipping of a primitive being deferred until later in the sequence of graphics processing (such as being done as part of the rendering process).

In the present embodiments, the clipping process for a primitive is performed by executing an appropriate (shader) program or programs (a “clip” shader or shaders) for the primitive by a shader core of the graphics processor.

The clip shader execution for a primitive that is to undergo the clipping process is triggered by the distributed binning core 49 sending an appropriate shading request to the compute endpoint 37.

In the present embodiments, the clipping process operates to update the previously prepared binning data structure (primitive packet) that includes the primitive that has been clipped based on the results of the clipping process (to include the clipping result data).

Thus the clipping process will include (in the appropriate placeholder entries) in the binning data structure (primitive packet) that includes the primitive that has been clipped an appropriate set of primitive commands for that primitive, for example indicating a bounding box for the primitive, any required identifiers for the primitive, the (location of the) vertices (and attributes for those vertices) for the primitive, etc..

In the present embodiment, the bounding box that is included in a primitive packet for a primitive that has undergone the clipping process is the bounding box to be used for the primitive for the binning process originally (and so is not an “updated” bounding box that takes account of any result of the clipping process for the primitive (although that would be possible, if desired)).

The clipping process also includes in the binning data structure (primitive packet) an indication that the primitive underwent the clipping process (was clipped), in an embodiment in the form of an appropriate “clipped” primitive command. This will then allow the rendering process (for example) to identify that the primitive underwent the clipping process, and that, accordingly, there may be vertices generated as a result of the clipping process to process for the primitive.

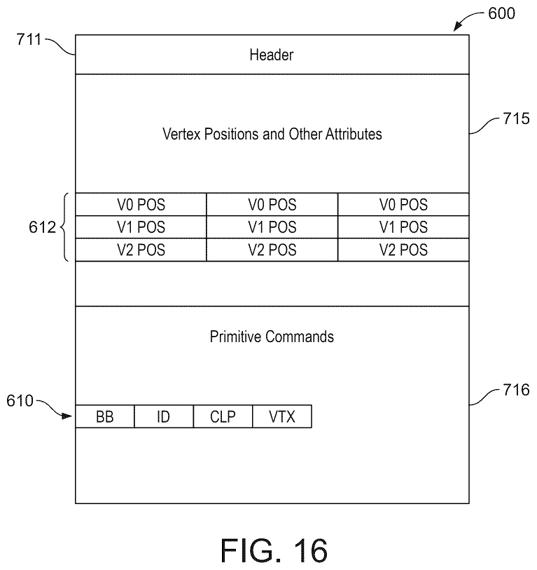

FIG. 16 illustrates this operation of the clipping process updating the relevant primitive packet for a primitive that undergoes the clipping process. FIG. 16 shows the primitive packet 600 of FIG. 14, but in this case, as shown in FIG. 16, the relevant (actual) primitive commands 610 and vertex attributes 612 for the vertices resulting from the clipping process have been updated in the previously allocated “placeholder” entries 601, 602 for that information for the primitive that underwent the clipping process.

The Applicants have further recognised in this regard that because the binning process allocates “placeholder” entries for vertices (e.g. vertex attributes) based on a worst case estimate of the effect of clipping on a primitive, there may in fact be allocated placeholder entries for which a vertex (vertex attribute data) does not result from the clipping process for a primitive.

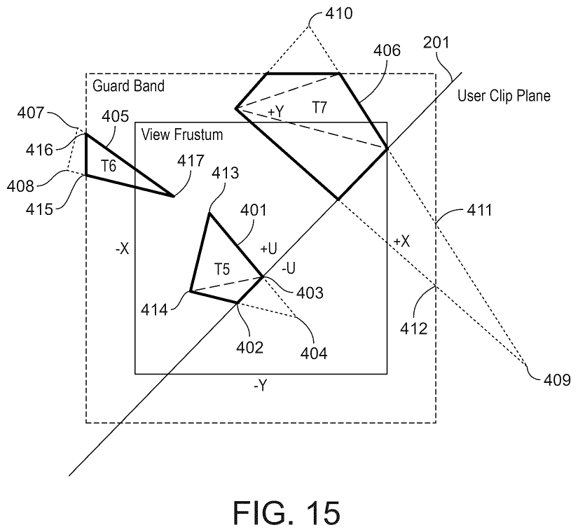

FIG. 15 illustrates this, and shows the actual clipping “result” for the primitives shown in FIG. 12.

As shown in FIG. 15, the clipping process will determine that for the triangle T5 401, four vertices (being two original vertices 413, 414 and two new vertices 402, 403) and two triangles will need to be processed for the triangle as a result of the clipping process.

For the triangle T6 405 the clipping against the view frustum guard band results in two of the original vertices 407, 408 not being needed and so only three vertices (two new vertices 415, 416 as a result of the clipping and one of the original vertices 417) are needed and there will be one triangle to process as a result of the clipping process.

For the triangle T7 406, when the clipping is actually performed, it will determine that two of the original vertices 409, 410 and two of the (potential) new vertices 411, 412 are not needed for the triangle, so five vertices and three triangles need to be processed for the triangle.

To allow for this, in the present embodiments the clipping process sets any placeholder entries in the binning data structures (packets) for vertices/vertex attributes which the clipping process does not in fact result in (generate (any data for)) to “not a number” (NaN) (for the graphics processing system in question), so that the rendering processing can recognise that those entries do not contain valid data.

Once the clipping processing has been completed for a primitive (and, e.g., the binning data structure(s) (packets) have been correspondingly updated), the primitive can be rendered.

In an embodiment, the clipping processing for all of the primitives that are to undergo a clipping process for the render output in question is completed (and the binning data structures correspondingly updated) before the rendering processing for the render output is begun.

In the present embodiments, the rendering/fragment processing is triggered and controlled by the fragment iterator 41 issuing appropriate fragment shading (rendering) tasks to the fragment endpoints 38 of the shader cores, with the fragment endpoints then triggering appropriate fragment shading etc., on the execution cores, accordingly.

The tasks will indicate an appropriate set of one or more tiles to be rendered by the shader core in question, together with an indication of the rendering/fragment processing that is to be performed for the tiles. The fragment endpoint 38 will then use the binning data structures generated by the distributed binning cores (as updated by any clipping processing) to identify the packets and primitives to be processed for a tile that they are processing, and perform appropriate rendering/fragment processing for the primitives in question for the tile in question.

The rendering/fragment processing that is performed for primitives and for a tile can comprise any suitable and desired rendering/fragment processing that can be performed, such as rasterising primitives to fragments and then performing fragment shading for the fragments, and/or performing ray tracing operations, etc..

Once a shader core has processed a tile, that tile will be written out to memory and the shader core will process the next tile (if any) that it is to process, and so on. This will be continued until the render output in question has been entirely generated.

This process will then be repeated for the next render output, and so on.

In the above embodiments, the binning process generates binning data structures in the form of bounding box hierarchies and packets containing primitives to be processed. It would also be possible for the binning process to generate other forms of binning data structures, such as respective primitive lists for tiles, and/or for sets of plural tiles, of a render output. In the case of alternative binning data structures, those data structures should again be generated in the appropriate manner based on the, e.g. worst case, estimate of the effect of clipping of a primitive.

In an embodiment, as well as determining whether a primitive could be clipped by a clip plane defined for the render output (so as to thereby determine whether the primitive should undergo a clipping process as part of its processing for the render output being generated), a primitive is also determined as needing to undergo a clipping process in the case where the primitive exceeds a particular threshold primitive size and/or in the case where the primitive intersects both the near and the far plane (which can be determined in any suitable and desired manner), and the depth range (between the near and far planes) is below a particular, in an embodiment selected, in an embodiment predetermined, threshold value (to assess this, a suitable conservative estimate of the depth range can be made).

It can be seen from the above, that the technology described herein, in its embodiments at least, can provide a more efficient mechanism for handling the clipping of primitives in a tile-based graphics processing system. This is achieved, in the embodiments of the technology described herein at least, by determining whether a primitive needs to undergo a clipping process, if so estimating an effect of the clipping process for the primitive and “binning” the primitive based on that estimated effect of the clipping process, and thereafter performing the clipping process for the primitive. The “clipped” primitive is then rendered.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a graphics processor when executing a tile-based graphics processing pipeline to generate an output, the graphics processing pipeline being executed comprising:
a sequence of one or more geometry processing stages to perform geometry processing;
a binning stage that performs a binning process to generate data structures for identifying geometry to be processed for respective rendering tiles of a render output being generated; and
a rendering stage for rendering tiles of a render output being generated;
the method comprising, when generating a render output in which primitives to be rendered can be clipped against a clip plane defined for the render output, for a primitive to be processed for the render output being generated:
determining whether the primitive should undergo a clipping process as part of its processing for the render output;
when it is determined that the primitive should undergo a clipping process as part of its processing for the render output, estimating an effect of clipping the primitive against clip planes defined for the render output;
the binning stage processing the primitive for inclusion in one or more data structures for identifying geometry to be processed for respective rendering tiles of the render output being generated based on the estimated effect of clipping of the primitive against clip planes defined for the render output;
thereafter performing a clipping process for the primitive; and
the rendering stage using the data structures generated by the binning stage and the result of the clipping process for the primitive for processing the primitive for the render output.

2. The method of claim 1, comprising determining whether the primitive should undergo a clipping process for the render output being generated by determining whether the primitive could be clipped by a clip plane defined for the render output.

3. The method of claim 1, wherein the estimating an effect of clipping the primitive against clip planes defined for the render output comprises estimating a number of vertices and/or of primitives that could result for the primitive as a result of the clipping of the primitive against clip planes defined for the render output.

4. The method of claim 1, comprising
determining whether a primitive should undergo a clipping process for a render output being generated by determining whether the primitive could be clipped by any of the clip planes defined for the render output;
counting the number of clip planes defined for the render output that the primitive is determined as potentially being clipped by; and
estimating the effect of the clipping of the primitive against clip planes defined for the render output by estimating a number of vertices that could result for the primitive as a result of the clipping of the primitive against clip planes defined for the render output based on the count of potentially clipping clip planes for the primitive.

5. The method of claim 1, wherein the binning process uses a bounding box for a primitive for the binning process, and the bounding box that is used by the binning process for a primitive that is determined as needing to undergo a clipping process comprises:
a bounding box that is based on the original vertices for the primitive; or
a bounding box that is based on the original vertices for the primitive and one or more of the clip planes defined for the render output.

6. The method of claim 1, wherein the binning stage processing the primitive for inclusion in one or more data structures for identifying geometry to be processed for respective rendering tiles of the render output being generated based on the estimated effect of clipping of the primitive against clip planes defined for the render output comprises:
allocating space in a binning data structure for storing a result of the clipping process for the primitive based on the estimated effect of clipping of the primitive against clip planes defined for the render output.

7. The method of claim 1, wherein the result of the clipping process for a primitive is provided to the rendering process in the binning data structures that are provided to the rendering process.

8. The method of claim 1, comprising the clipping process for the primitive including a result of the clipping process for the primitive in a binning data structure or structures that has been previously generated by the binning process.

9. The method of claim 1, wherein the binning stage processing the primitive for inclusion in one or more data structures for identifying geometry to be processed for respective rendering tiles of the render output being generated based on the estimated effect of clipping of the primitive against clip planes defined for the render output comprises:
allocating placeholder entries in a binning data structure for storing result data from the clipping process for the primitive based on the estimated effect of clipping of the primitive against clip planes defined for the render output;
and the method further comprises:
when the clipping process generates clipping process result data for the primitive, storing that result data in one or more of the placeholder entries allocated in the binning data structure for the primitive.

10. The method of claim 1, wherein the binning stage processing the primitive for inclusion in one or more data structures for identifying geometry to be processed for respective rendering tiles of the render output being generated based on the estimated effect of clipping of the primitive against clip planes defined for the render output comprises:
allocating placeholder entries in a binning data structure for storing result data from the clipping process for the primitive based on the estimated effect of clipping of the primitive against clip planes defined for the render output;
and the method further comprises:
when the clipping process does not generate clipping process result data for a placeholder entry allocated in the binning data structure for the primitive, providing an indication that the placeholder entry in the binning data structure is not valid.

11. A graphics processor operable to execute a tile-based graphics processing pipeline to generate an output, the graphics processor comprising one or more processing circuits configured to execute a graphics processing pipeline comprising:
a sequence of one or more geometry processing stages to perform geometry processing;
a binning stage that performs a binning process to generate data structures for identifying geometry to be processed for respective rendering tiles of a render output being generated; and
a rendering stage for rendering tiles of a render output being generated;
the graphics processor comprising a processing circuit configured to, when generating a render output in which primitives to be rendered can be clipped against a clip plane defined for the render output:
determine for a primitive to be processed for the render output being generated whether the primitive should undergo a clipping process as part of its processing for the render output; and
when it is determined that the primitive should undergo a clipping process as part of its processing for the render output, estimate an effect of clipping the primitive against clip planes defined for the render output;
wherein:
the binning stage processing circuit is configured to process a primitive for which it has been determined that the primitive should undergo a clipping process as part of its processing for a render output for inclusion in one or more data structures for identifying geometry to be processed for respective rendering tiles of a render output being generated based on the estimated effect of clipping of the primitive against clip planes defined for the render output;
the graphics processor comprises a clipping processing circuit configured to, after the binning stage processing circuit has processed a primitive for which it has been determined that the primitive should undergo a clipping process as part of its processing for a render output for inclusion in one or more data structures for identifying geometry to be processed for respective rendering tiles of the render output being generated based on the estimated effect of clipping of the primitive against clip planes defined for the render output, perform a clipping process for the primitive; and
the rendering stage processing circuit is configured to use the data structures generated by the binning stage and the result of the clipping process for a primitive that has undergone a clipping process for a render output for processing the primitive for the render output.

12. The graphics processor of claim 11, wherein the processing circuit is configured to determine whether a primitive should undergo a clipping process for the render output being generated by determining whether the primitive could be clipped by a clip plane defined for the render output.

13. The graphics processor of claim 11, wherein the processing circuit is configured to estimate an effect of clipping a primitive against clip planes defined for a render output by estimating a number of vertices and/or of primitives that could result for the primitive as a result of the clipping of the primitive against clip planes defined for the render output.

14. The graphics processor of claim 11, wherein the processing circuit is configured to:
determine whether a primitive should undergo a clipping process for a render output being generated by determining whether the primitive could be clipped by any of the clip planes defined for the render output;
count the number of clip planes defined for the render output that the primitive is determined as potentially being clipped by; and
estimate the effect of the clipping of the primitive against clip planes defined for the render output by estimating a number of vertices that could result for the primitive as a result of the clipping of the primitive against clip planes defined for the render output based on the count of potentially clipping clip planes for the primitive.

15. The graphics processor of claim 11, wherein the binning process uses a bounding box for a primitive for the binning process, and the bounding box that is used by the binning process for a primitive that is determined as needing to undergo a clipping process comprises:
a bounding box that is based on the original vertices for the primitive; or
a bounding box that is based on the original vertices for the primitive and one or more of the clip planes defined for the render output.

16. The graphics processor of claim 11, wherein the binning stage processing circuit is configured to process a primitive for inclusion in one or more data structures for identifying geometry to be processed for respective rendering tiles of a render output being generated based on an estimated effect of clipping of the primitive against clip planes defined for a render output by:
allocating space in a binning data structure for storing a result of the clipping process for the primitive based on the estimated effect of clipping of the primitive against clip planes defined for the render output.

17. The graphics processor of claim 11, wherein a result of the clipping process for a primitive is provided to the rendering process in the binning data structures that are provided to the rendering process.

18. The graphics processor of claim 11, wherein the clipping processing circuit is configured to include a result of the clipping process for a primitive in a binning data structure or structures that has been previously generated by the binning process.

19. The graphics processor of claim 11, wherein:
the binning stage processing circuit is configured to process a primitive for inclusion in one or more data structures for identifying geometry to be processed for respective rendering tiles of a render output being generated based on an estimated effect of clipping of the primitive against clip planes defined for a render output by:
allocating placeholder entries in a binning data structure for storing result data from the clipping process for the primitive based on the estimated effect of clipping of the primitive against clip planes defined for the render output;
and the clipping processing circuit is configured to:
when the clipping process generates clipping process result data for a placeholder entry allocated in a binning data structure for the primitive, store that result data in the placeholder entry allocated in the binning data structure for the primitive; and
when the clipping process does not generate clipping process result data for a placeholder entry allocated in a binning data structure for the primitive, provide an indication that the placeholder entry in the binning data structure is not valid.

20. A non-transitory computer readable storage medium storing computer software code which when executing on one or more processors performs a method of operating a graphics processor when executing a tile-based graphics processing pipeline to generate an output, the graphics processing pipeline being executed comprising:
a sequence of one or more geometry processing stages to perform geometry processing;
a binning stage that performs a binning process to generate data structures for identifying geometry to be processed for respective rendering tiles of a render output being generated; and
a rendering stage for rendering tiles of a render output being generated;
the method comprising, when generating a render output in which primitives to be rendered can be clipped against a clip plane defined for the render output, for a primitive to be processed for the render output being generated:
determining whether the primitive should undergo a clipping process as part of its processing for the render output;
when it is determined that the primitive should undergo a clipping process as part of its processing for the render output, estimating an effect of clipping the primitive against clip planes defined for the render output;
the binning stage processing the primitive for inclusion in one or more data structures for identifying geometry to be processed for respective rendering tiles of the render output being generated based on the estimated effect of clipping of the primitive against clip planes defined for the render output;
thereafter performing a clipping process for the primitive; and
the rendering stage using the data structures generated by the binning stage and the result of the clipping process for the primitive for processing the primitive for the render output.
